(19) United States
(12) Patent Application Publication
(10) Pub. No.: US 2026/0292816 A1
(43) Pub. Date: Sep. 24, 2026

(54) EVENT-BASED INDICATION (EBI) MULTIPLEXING WITH UPLINK SHARED CHANNEL

(71) Applicant: InterDigital Patent Holdings, Inc., Wilmington, DE (US)

(72) Inventors: Nazli Khan Beigi, Longueuil (CA); Jonghyun Park, Syosset, NY (US); Paul Marinier, Brossard (CA); Moon IL Lee, Melville, NY (US); Tao Deng, New York, NY (US); Aata El Hamss, Laval (CA); Virgile Garcia, Antibes (FR)

(73) Assignee: InterDigital Patent Holdings, Inc., Wilmington, DE (US)

(21) Appl. No.: 19/088,379

(22) Filed: Mar. 24, 2025

(51) Int. Cl. H04W 72/1268; H04B 17/318; H04L 5/00; H04W 24/10

(52) U.S. Cl. CPC H04W 72/1268; H04B 17/328; H04L 5/0005; H04W 24/10

(57) ABSTRACT

A wireless transmit receive unit (WTRU) is configured with event-based indication (EBI) reporting resources in PUSCH resources. The WTRU may trigger the events based on an ongoing DL reception (e.g., PDSCH). The WTRU multiplexes the event-based UCI including codepoints corresponding to the triggered event in a PUSCH. The WTRU determines whether to use the resources or not for reporting and indication of the L1-events based on one or more conditions.

### BACKGROUND

Uplink control signaling may be based on MAC-CE signaling or via UCI. The UCI can be transmitted or multiplexed via PUCCH or PUSCH transmission, where the UCI can include CSI reports, such as CSI report part 1, CSI report part 2, etc., for example, HARQ-ACK, or Unused Transmission Occasion (UTO)-UCI. On the other hand, MAC-CE can be included in a configured and/or scheduled UL, such as PUSCH, for example, for which the WTRU has a grant. However, this signaling and reporting in both UCI and MAC-CE usually correspond to some previously measured CSI, generated HARQ-ACK codebooks, events, and the like. That is, currently, the events or signaling indicated via UCI and MAC-CE go back in time to an event measured or detected in several slots ago. This may limit real-time, L1-measurements and events to be reported. That is, in case an L1-event is triggered, by the time the event is reported based on current UCI and MAC-CE signaling, latency may occur.

### SUMMARY

A wireless transmit receive unit (WTRU) is configured with event-based indication (EBI) reporting resources in PUSCH resources. The WTRU may trigger the events based on an ongoing DL reception (e.g., PDSCH). The WTRU multiplexes the event-based UCI including codepoints corresponding to the triggered event in a PUSCH. The WTRU determines whether to use the resources or not for reporting and indication of the L1-events based on one or more conditions.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of multiplexing UCI on PUSCH;

FIG. 3 illustrates an example of HARQ-ACK timing indication in PUCCH;

FIG. 4 illustrates an example of SBFD configuration in TDD framework;

FIG. 5 illustrates an example of event-based indication (EBI) multiplexed on PUSCH; and

FIG. 6 illustrates a method for event-based indication (EBI) multiplexing with an uplink shared channel.

### DETAILED DESCRIPTION

A wireless transmit receive unit (WTRU) is configured with event-based indication reporting resources in PUSCH resources. The WTRU may trigger the events based on an ongoing DL reception (e.g., PDSCH). The WTRU multiplexes the event-based UCI including codepoints corresponding to the triggered event in a PUSCH. The WTRU determines whether to use the resources or not for reporting and indication of the L1-events based on one or more conditions.

A WTRU may be configured with reserved resources for “Event-Based” indication (EBI) to be multiplexed on PUSCH. The WTRU may detect a triggered event (e.g., L1-event), e.g., based on one or more channel or interference measurements. The WTRU may determine the configurations to multiplex and transmit EBIs, based on one or more conditions, such as time limits, power limits, and duplex mode, for example. The WTRU may use the reserved EBI reporting resources, and the WTRU sends the codepoint corresponding to the triggered event.

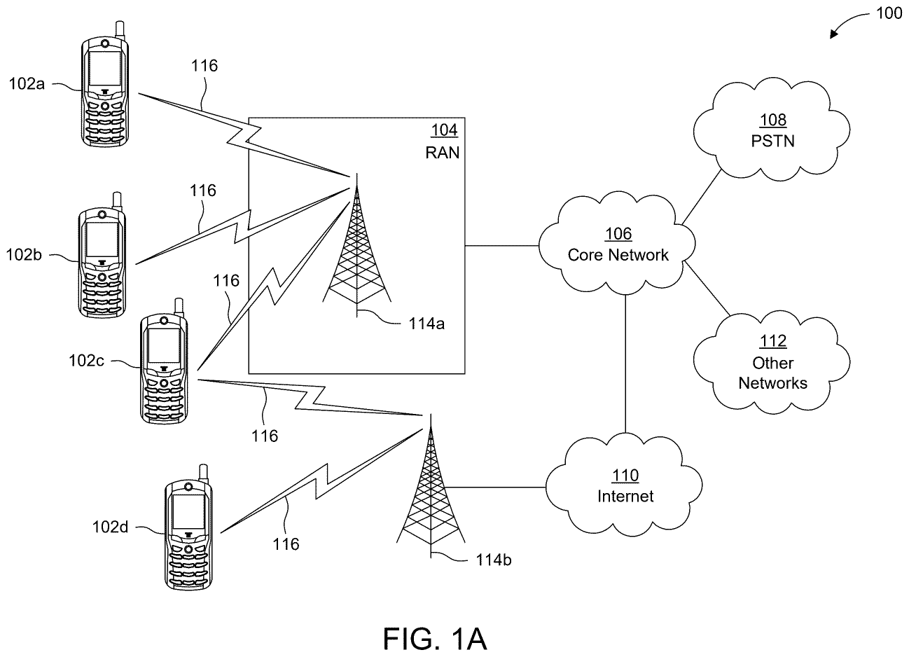

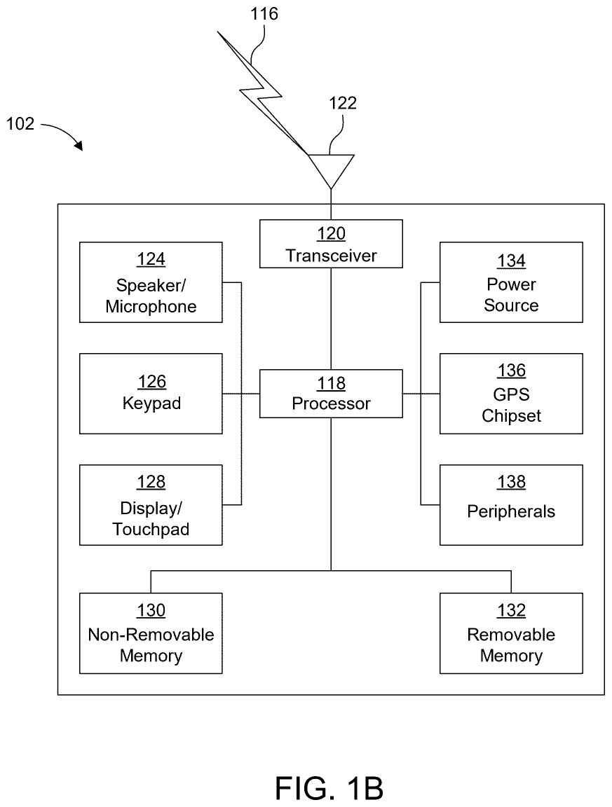

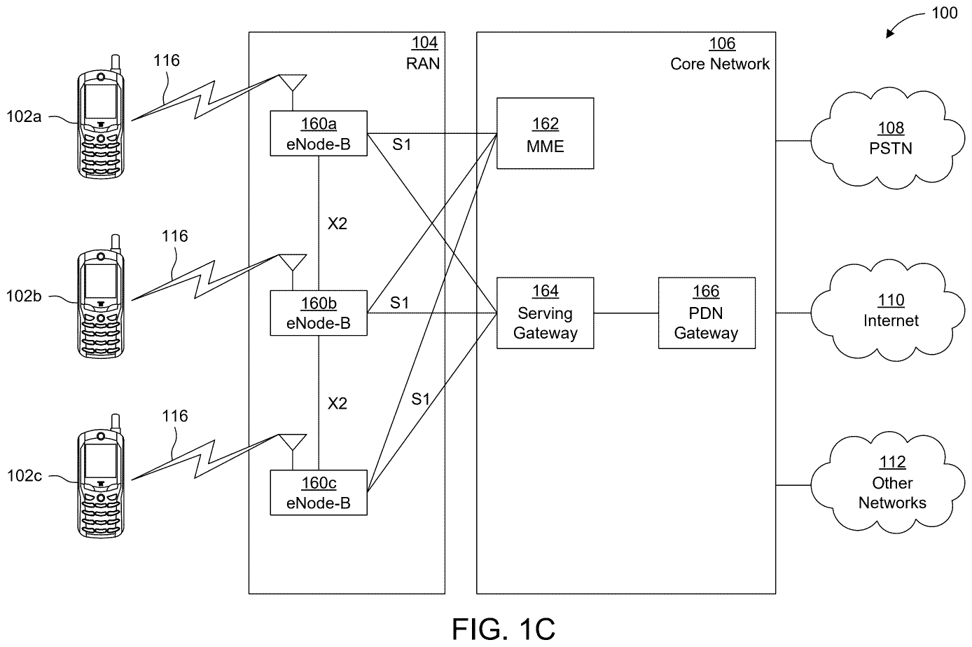

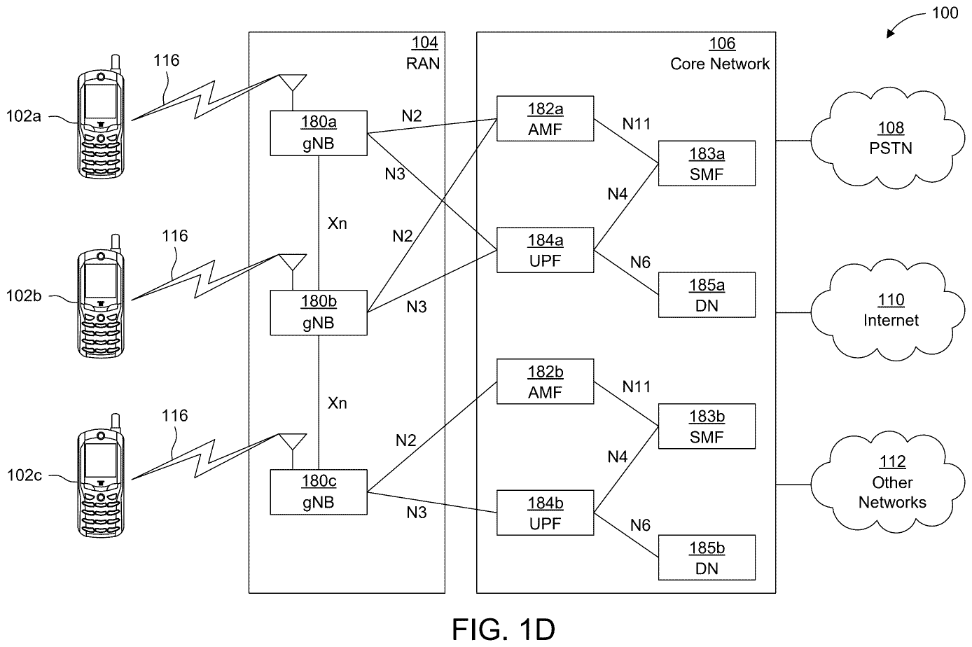

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80 +80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

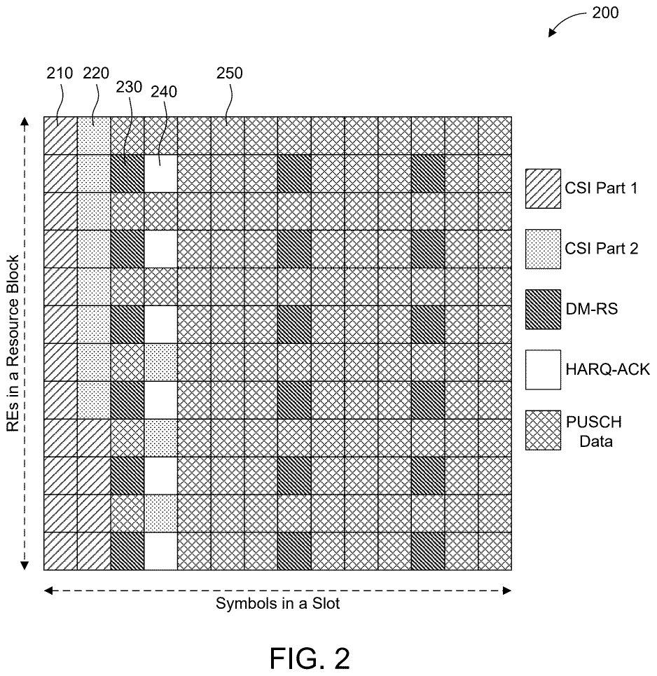

FIG. 2 illustrates an example of multiplexing UCI on PUSCH 200. FIG. 2 illustrates the REs, which is a block in FIG. 2, in a resource block, and symbols in a slot, as illustrated 14 symbols in the subcarrier, across each axis. As illustrated, several of the REs are included within CSI part 1 210. Additional REs are included in CSI part 2 220. Both the REs in CSI part 1 210 and CSI part 2 220 are included in consecutive symbols at the beginning of the PUSCH. demodulation reference signal (DM-RS) 230 REs are spaced throughout the PUSCH, as illustrated. The HARQ-ACK 240 REs are included in the fourth slot in the example. PUSCH data 250 REs make up the rest of the PUSCH block.

Multiplexing UCI in PUSCH 200 is supported when UCI and PUSCH transmissions coincide in time, either due to transmission of a UL-SCH transport block or due to triggering of A-CSI transmission without UL-SCH transport block and are associated with the same priority (high/low). In addition, HARQ-ACK multiplexing of a certain priority in PUSCH of a different priority is supported when HARQ-ACK 240 and PUSCH 250 transmissions coincide in time, either due to transmission of a UL-SCH transport block or due to triggering of A-CSI transmission without UL-SCH transport block. For example, UCI carrying HARQ-ACK 240 feedback with 1 or 2 bits is multiplexed by puncturing PUSCH 250 and in all other cases, UCI is multiplexed by rate matching PUSCH.

The UCI multiplexed on PUSCH 250 includes either CSI report 210, 220 or HARQ-ACK 240 reports. The UCI information is transmitted only in the OFDM symbols that are not used for DM-RS 230 transmission. The coded HARQ-ACK 240 bits are placed from the OFDM symbol, after the first consecutive DM-RS 230 OFDM symbols. The coded CSI part 1 210 or CSI part 2 220 bits are placed at the starting OFDM symbol that is not used for DM-RS 230 in the shared channel symbol allocation.

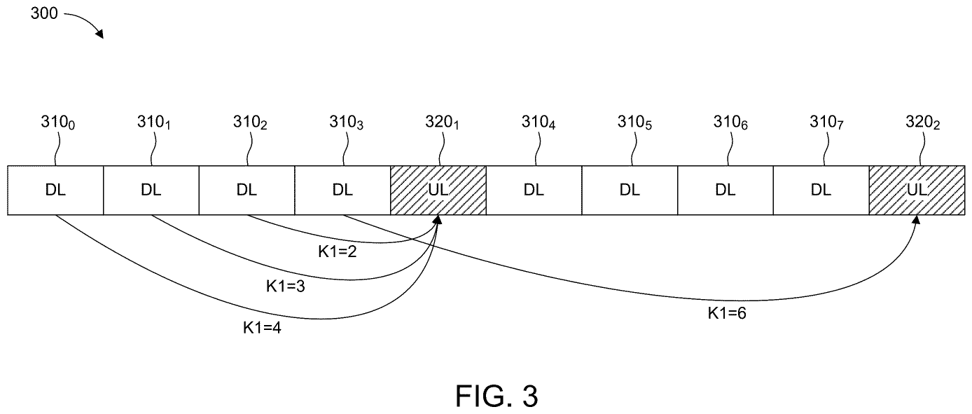

FIG. 3 illustrates an example of HARQ-ACK timing indication 300 in PUCCH. In example 300, there are downlink 310₀, 310₁, 310₂, 310₃, 310₄, 310₅, 310₆, 310₇ (collectively or generally referred to as downlink 310) and uplink 320₁, 320₂. (collectively or generally referred to as uplink 320).

The timing transmission of HARQ ACK/NACK is configurable with one example illustrated in FIG. 3. The HARQ ACK/NACK timing for the reception of a downlink signal and/or channel can be configured by one or more higher-layer parameters, indicating parameter K1. The parameter K1 indicates an index specified in RRC parameter, e.g., via dl-DataToUL-ACK in PUCCH-Config. For example, for a slot configuration DDDDU illustrated in FIG. 3 as DL 310₀, 310₁, 310₂, 310₃ with UL 320₁, then DL 310₄, 310₅, 310₆, 310₇ with UL 320₂, the HARQ ACK/NACK could be configured, so that the ACK/NACK information bits and/or codebooks could be multiplexed and transmitted at one or more UL slots by specifying K1.

As illustrated, the latency of detected L1 events, such as if K1 registers an L1 event, before the system is alerted, three additional DLs 310₁, 310₂, 310₃ are performed. In a usual scenario, each of these three additional DLs 310₁, 310₂, 310₃ also include an L1 event. As such, DLs 310₁, 310₂, 310₃ are wasted communications.

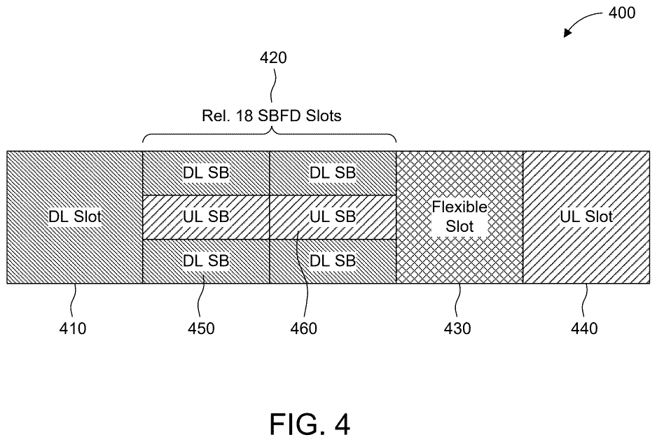

FIG. 4 illustrates an example of subband non-overlapping full duplex (SBFD) configuration 400 in TDD framework. SBFD configuration 400 includes a DL slot 410, two SBFD slots 420, a flexible slot 430 and an UL slot 440. DL slot 410, flexible slot 430 and UL slot 440 mat operate in full-duplex (FD) operation, while SBFD slots 420 are divided using half-duplex (HD) mode. As illustrated in FIG. 4, SBFD slots 420 are divided into DL SBs 450 and UL SBs 460. Specifically, the each SBFD slot 420 is divided into thirds including a first DL SB 450, a UL SB 460, and a second DL SB 450. By creating SBFD slot 420 and UL SB 460 occurs instead of waiting and creating latency as described with respect to the timing indication 300 of FIG. 3.

SBFD may be a foundation in improving conventional TDD operation by enhancing UL coverage, improving capacity, reducing latency, and so forth. The conventional TDD is based on splitting the time domain between the uplink and downlink. Full duplex, or more specifically, SBFD at the gNB within a conventional TDD band is allowed.

The uplink control signaling 460 may be based on MAC-CE signaling or via UCI. The UCI can be transmitted or multiplexed via PUCCH or PUSCH transmission, where the UCI can include CSI reports, such as CSI report part 1, CSI report part 2, etc., for example, HARQ-ACK, or Unused Transmission Occasion (UTO)-UCI. On the other hand, MAC-CE can be included in a configured and/or scheduled UL, such as PUSCH, for example, for which the WTRU has a grant. However, this signaling and reporting in both UCI and MAC-CE usually correspond to some previously measured CSI, generated HARQ-ACK codebooks, events, and the like. That is, currently, the events or signaling indicated via UCI and MAC-CE go back in time to an event measured or detected in several slots ago. This may limit real-time, L1-measurements and events to be reported. That is, in case an L1-event is triggered, by the time the event is reported based on current UCI and MAC-CE signaling, there may be drastic disadvantage in terms of latency.

For example, consider a case scenario where a WTRU detects an L1-event, such as low measured RSRP, high measured interference, such as CLI, for example, high determined hypothetical BLER, lower RSRP of a current beam compared with that of a new beam and a threshold, corresponding to a received PDSCH or Rx beam. The detected L1-event may result in HARQ-NACK for the corresponding PDSCH, or the need for beam switching for the corresponding Rx beam. This may be, for example, a current beam or an RS of an indicated TCI-state. According to the current mechanism of CSI reporting or events' indication of FIG. 2, it might take up to several slots for the WTRU to get to the upcoming scheduled or configured PUCCH or PUSCH occasion for transmitting the indication.

In another example, where there is no grant, then there may be latency, because according to the current mechanism for acquiring a grant, the WTRU may have to transmit a scheduling request (SR) using UCI to request a grant, then transmit a MAC-CE containing buffer status report (BSR) to request resources to transmit the MAC CE containing the event report.

As set forth above with respect to FIG. 4, SBFD indication 400 may be used. A WTRU may receive configurations (e.g., from a gNB, a node, or a device) for full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time the WTRU either performs a UL transmission or a DL reception (e.g., not both UL and DL simultaneously at the given time). The WTRU may operate in an FD mode for communicating with the gNB, e.g., if a corresponding WTRU capability signal is reported to the gNB and/or the WTRU receives a confirmation signal (e.g., enabling the FD, configuring the FD mode) in response to transmitting the WTRU capability signal.

The FD operation may imply at a given time a transmitter (e.g., the gNB and/or the WTRU) may simultaneously transmit a first signal and receive a second signal. The FD operation may comprise a subband overlapping FD (e.g., in-band FD (IBFD)) operation where a first frequency-domain resource (e.g., RBG(s), RB(s), RE(s)) allocated for the first signal may have a full (or at least a partial) overlap with a second frequency-domain resource allocated for the second signal. The FD operation may comprise a SBFD operation where a first frequency-domain resource allocated for the first signal (e.g., assigned within a configured SBFD subband, e.g., DL subband 450, usable DL PRBs) does not have an overlap with a second frequency-domain resource allocated for the second signal (e.g., assigned within a configured SBFD subband, e.g., UL subband 460, usable UL PRBs).

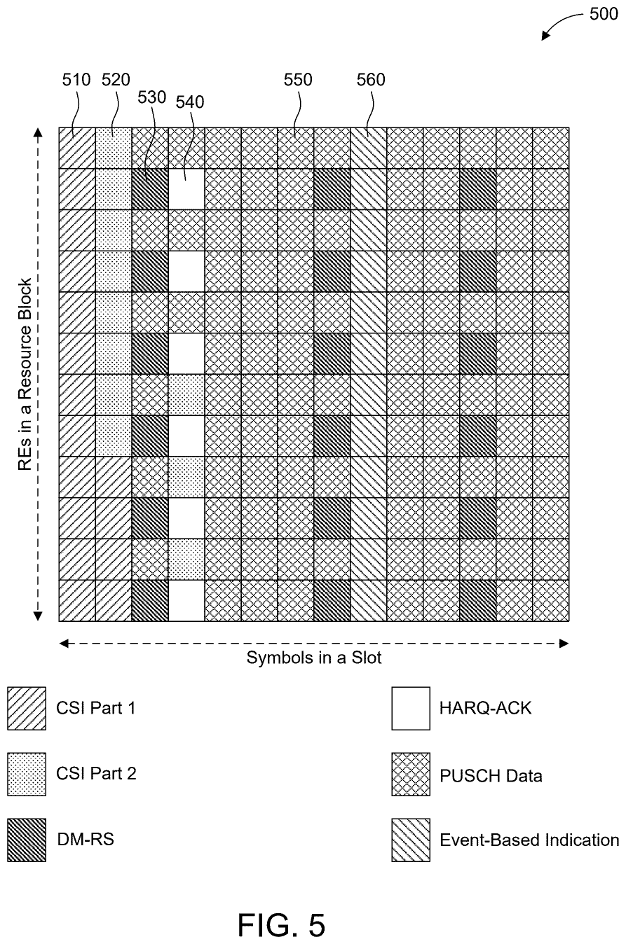

FIG. 5 illustrates an example of event-based indication (EBI) multiplexed on PUSCH 500. Similar to FIG. 2 multiplexing UCI on PUSCH 200, EBI multiplexed on PUSCH 500 may include the REs, which is a block in FIG. 5, in a resource block, and symbols in a slot, as illustrated 14 symbols in the subcarrier, across each axis. As illustrated, several of the REs are included within CSI part 1 510. Additional REs are included in CSI part 2 520. Both the REs in CSI part 1 510 and CSI part 2 520 are included in consecutive symbols at the beginning of the PUSCH. DM-RS 530 REs are spaced throughout the PUSCH, as illustrated. The HARQ-ACK 540 REs are included in the fourth slot in the example. PUSCH data 550 REs make up the majority of the PUSCH block. EBI 560 are included as the REs for an entire symbol in the example. The use of the entire symbol for EBI 560 may be one end of the spectrum where the EBI 560 capture the REs for an entire symbol. As would be understood by those in the field, EBI 560 may be a single RE, for example, or two REs, for example, that may be spaced within the block. In some examples, more REs may be defined as EBI 560 using a full symbol if the WTRU is expected to have an issue, or more likely have an issue, while less REs may be defined as EBI 560 if the WTRU is not expected to have an issue, such as a single RE, for example. In the extreme, if no issue is expected no REs need be defined as EBI 560.

Simplified UCI multiplexing in PUSCH and adaptable UCI transmission with payload variations are described. A WTRU may be configured with reserved resources for EBI 560 reporting in DG and/or CG PUSCH occasions. The WTRU may trigger the events based on CSI measurements or an ongoing DL reception (e.g., PDSCH). The WTRU may multiplex the codepoints associated with triggered event in a nearest PUSCH, where the PUSCH may fully overlap, partially overlap, or not overlap with the received PDSCH, e.g., in time and/or frequency resources. The WTRU may determine on whether to use the reserved resources for reporting an indication of the L1-events based on one or more conditions. The WTRU measuring channel and interference parameters and triggering real-time events can report the events and potentially the reason for the trigger faster to a base station (BS, e.g., cell, TRP, gNB), allowing faster decision making at the WTRU, such as on link adaptation, re-transmission, scheduling, and the like, for example.

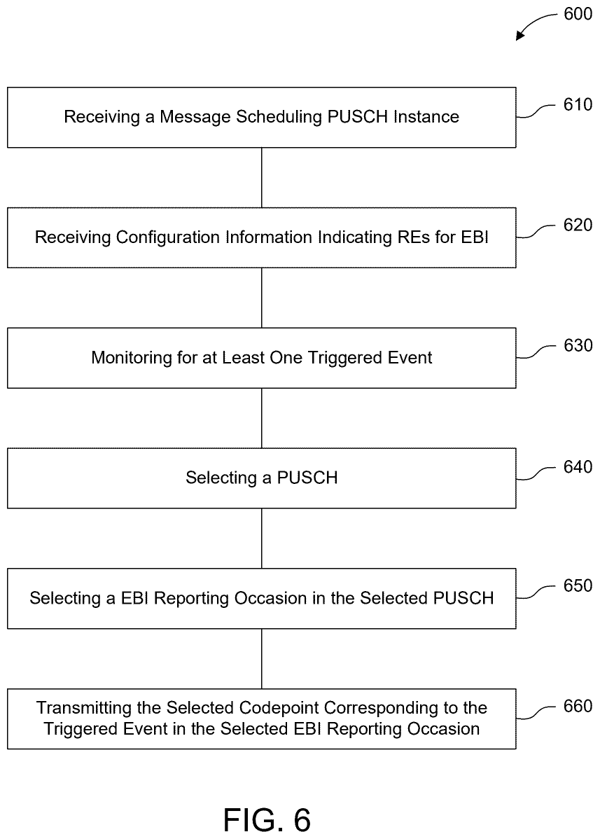

FIG. 6 illustrates a method 600 for event-based indication (EBI) multiplexing with an uplink shared channel. Method 600 for a wireless transmit receive unit (WTRU) to perform event-based indication (EBI) multiplexing with one or more physical uplink (UL) shared channels (PUSCH) may include receiving at 610 a message scheduling one or more PUSCH instances, receiving at 620 configuration information indicating a plurality of resource elements (REs) for EBI that are configured to be multiplexed with one or more PUSCH, monitoring at 630 for at least one event, on a condition that a monitored event is triggered, selecting at 640 a PUSCH instance from the scheduled one or more PUSCH instances, selecting at 650 an EBI reporting occasion in the selected PUSCH instance, and transmitting at 660 a codepoint corresponding to the monitored event utilizing the selected EBI reporting occasion. Method may further include determining the codepoint to be used to report the triggered monitored event. While PUSCH is described herein, any UL shared channel may be used with PUSCH being an example of an UL shared channel.

At 610, method 600 includes receiving a message scheduling one or more PUSCH instances. This message may include a configured grant (CG)-PUSCH or dynamic grant (DG)-PUSCH.

At 620, method 600 includes receiving configuration information indicating a plurality of resource elements (REs) for EBI that are configured to be multiplexed with one or more PUSCH or other one or more UL shared channels. The configuration information may be one of semi-statically configured or a dynamic indication. The configuration information may include time and frequency resources of the EBI reporting occasions. The configuration information may include power configuration on EBI reporting. For example, the power configuration may include a 3 dB power boost compared to the PUSCH, such as PUSCH REs, for example. Additional details regarding receiving at 620 is provided below.

At 630, method 600 includes monitoring for at least one event. This monitoring may include triggering events, such as an L1-event, for example. The monitoring for at least one event may include at least one of strong CLI, high hypothetical block error rate (BLER), low reference signal received power (RSRP), low signal-to-noise ratio (SNR), beam reporting, or LTM events. The monitoring for at least one event is based on at least one of one or more channel or interference measurements, or one or more reference signals. One or more reference signals may include SSB, CSI-RS, PDSCH DM-RS, PDCCH DM-RS, SRS, and the like, for example. Additional details regarding monitoring at 630 is provided below.

At 640, method 600 includes that selecting a PUSCH instance from the scheduled one or more PUSCH instances may include selecting the closest available PUSCH instance in time to the triggering based on the monitored event. As will be described in more detail below, the closest available PUSCH instance need not be the next instance. In case an L1-event is triggered, the WTRU selects the closest available PUSCH in time. The WTRU may also determine one or more codepoints to be used for reporting the triggered event. Additional details regarding selecting at 640 is provided below.

At 650, method 600 includes that the selecting an EBI reporting occasion in the selected PUSCH instance may be based on at least one of time limits, power or duplex mode. The WTRU may determine and/or select the EBI reporting occasions, and mode of operation be used for EBI reporting in the selected closest PUSCH, based on one or more of the following example conditions and scenarios: Additional details regarding selecting at 650 is provided below.

At 660, method 600 includes transmitting a codepoint corresponding to the monitored event utilizing the selected EBI reporting occasion. In an example, a WTRU may be configured with one or more codepoints for EBI reporting, where the codepoints may have different lengths. The codepoint lengths may be associated with type of the events and the types or details of the reports to be reported. The WTRU may select and/or determine the codepoint and the codepoint length to be used based on one or more conditions, including EBI reporting occasion type, power limits, events priority, etc., as described herein. The benefit in having different codepoints and different codepoint length is enabling adaptable UCI transmission with payload variations. The variations may be used based on collision and priority handling. In an example, the WTRU may determine, be configured, and/or indicated to handle the potential collisions in EBI report transmissions. Additional details regarding transmitting at 660 is provided below.

As set forth, at 620, method 600 includes receiving configuration information indicating a plurality of resource elements (REs) for EBI that are configured to be multiplexed with one or more PUSCH or other one or more UL shared channels. The configuration information may be one of semi-statically configured or a dynamic indication. The configuration information may include time and frequency resources of the EBI reporting occasions. The configuration information may include power configuration on EBI reporting. For example, the power configuration may include a 3 dB power boost compared to the PUSCH, such as PUSCH REs, for example.

The configuration information may include one or more codepoints, each of the one or more codepoints being associated with one or more L1 events. Codepoints, such as hard-coded EBI information bits, a set of EBI coded bit fields, pre-defined or (pre-)configured EBI message types, multiple different EBI codepoints, and the like, for example, may each be associated with one or more L1-events. Codepoints may include short codepoints (event indication), long codepoints (extra information on the event), and dummy codepoints (in case of no events). The configuration information may include at least one EBI occasion type. The at least one occasion type may be a first type EBI occasion with reserved REs for EBI reporting. First type EBI occasions may be close to the beginning of the PUSCH start symbol, where dummy codepoints are transmitted in case of no events, rate-matching is used for multiplexing, and long codepoints are used.

The at least one occasion type may be a second type EBI occasion without reserved REs for EBI reporting. Second type EBI occasions may be near to the end of the PUSCH occasion, where PUSCH data is punctured for multiplexing the EBI reporting, and short codepoints are used.

The configuration information may include at least one of EBI repetition, priority levels, error control coding, and carrier configuration.

In an example, a WTRU may determine, receive, be configured, and/or indicated with one or more time and frequency resources for indicating, reporting, and/or sending one or more indications. The indications may be based on one or more EBI. For example, the time and frequency resources may indicate one or more EBI reporting occasions. On the other hand, the reports may be based on non-event-based indications, scheduled indications, determined indications, configured indications, Uplink Control Indications (UCI), HARQ-ACK, periodic, aperiodic, and/or semi-persistent CSI reporting, and so forth. The WTRU may receive one or more corresponding configuration information and/or indications on the reporting occasions, for example via SIB, RRC, MAC-CE, DCI.

Herein, for the brevity of discussion, the reporting and indications may comprise EBI, however the solutions and examples may equally be employed for cases with other reporting and and/or indications (e.g., CSI report, HARQ-ACK, configured reports, dynamic reports, UCI, event-based UCI, etc.).

As an example, referring to FIG. 5, where the WTRU may be configured with a PUSCH occasion, for example in a slot, the WTRU may be configured with one or more first sets of resource elements (REs) in time and frequency resources within the PUSCH occasion and/or PUSCH slot. In an example, the WTRU may be configured to multiplex EBI reporting in the n-th symbol (e.g., Symbol #9) (e.g., within the slot). In another example, the WTRU may be configured to multiplex the EBI reporting in one or more symbols after a reference symbol, e.g., the symbol with the second set of DM-RS resources (e.g., within the PUSCH slot). In an example, the WTRU may be configured to use one or more REs in the configured symbol(s) for EBI reporting. For example, the WTRU may be configured to use all the REs in the configured symbol(s). In another example, the WTRU may be configured to use a subset of REs in the configured symbol(s). After a (pre)configured event is triggered, the WTRU may use the first REs for EBI reporting. The events may be based on L1-measurements and/or L1-events. The WTRU may multiplex the EBI reporting in the PUSCH occasion. The WTRU may send one or more (pre)configured codepoints for EBI reporting. In another example, the WTRU may be configured with one or more second set of REs for reporting and/or sending one or more indications (e.g., CSI report, HARQ-ACK, etc.), reference signals (e.g., DM-RS), as illustrated in FIG. 5.

In an example, the WTRU may determine, receive, be configured, and/or indicated with one or more report configurations, where the report configurations may include time and frequency resources for one or more EBI reporting occasions for sending EBI. For example, the report configurations may be based on one or more CSI report configurations. The report configurations may include a first set of time and frequency resources, REs, OFDM symbols, etc. for sending one or more (e.g., CSI) reports and/or indications. The report configurations may include a second set of time and frequency resources, REs, OFDM symbols, etc. for configuring EBI reporting occasions for sending one or more event-based reports and/or indications. In an example, the first and second sets of the time and frequency resources may be the same or different from each other.

In an example, one or more resources for EBI reporting occasions may be part of one or more UL transmissions. In an example, the UL transmission(s) may be based on one or more PUSCH, PUCCH, etc. In an example, the time and frequency resources for EBI reporting occasions may be configured and/or reserved within and/or associated with one or more PUSCH occasions. For example, the WTRU may use the reserved time and frequency resources for sending the reports and/or indications in a configured-grant (CG) PUSCH; in another example, the WTRU may use the reserved time and frequency resources for sending the reports and/or indications in a dynamic-grant (DG) PUSCH, and so forth.

In an example, the WTRU may receive the configuration information regarding the EBI reporting occasions via RRC, MAC-CE, DCI, etc. For example, the WTRU may receive the configuration information regarding the EBI reporting occasions in a separate control signaling, e.g., via PDCCH; the WTRU may receive the configuration information regarding the EBI reporting occasions as part of the configuration information and/or indications received for configuring and/or scheduling a DL grant, e.g., PDSCH; the WTRU may receive the configuration information regarding the EBI reporting occasions as part of the configuration information and/or indications received for configuring and/or scheduling an UL grant, e.g., PUSCH, and so forth. Moreover, the WTRU may receive the configuration information and/or indications via separate DCI, MAC-CE, and/or RRC signaling. After receiving the configuration information regarding the EBI reporting occasions, the WTRU can use them for sending EBI reports in case any of the configured events may be triggered.

In an example, different EBI reporting occasions may be configured with different number of REs. In an example, a first EBI reporting occasion may be configured to include a first number of REs, a second EBI reporting occasion may be configured to include a second number of REs. For example, the WTRU may determine, be configured, and/or indicated to select and use the configured EBI reporting occasions based on one or more of the conditions, e.g., based on codepoint length, event's priority, channel conditions, error control coding rate, etc.

In an example, the configuration information regarding the EBI reporting may include an enable/disable indication. For example, the WTRU may receive a flag indication, where a first value (e.g., value one) may indicate that the EBI reporting may be enabled, and a second value (e.g., value zero) may indicate that the EBI reporting may be disabled. In case the EBI reporting is enabled, the WTRU may be (pre)configured, indicated, and/or receive one or more configuration information on the start time, the time-window, and/or the end time, during which the EBI reporting may be enabled. In an example, the WTRU may be (pre)configured to start enabling monitoring for the configured events and enable EBI reporting as soon as receiving the enabling indication. The WTRU may be (pre)configured to continue monitoring for the configured events and EBI reporting for a (pre)configured and/or determined time duration. The WTRU may be (pre)configured to continue monitoring for the configured events and EBI reporting until the disabling indication is received. In case the EBI reporting is disabled, the WTRU may be (pre)configured, indicated, and/or receive one or more configuration information on the time after which the EBI reporting may be disabled. In an example, the WTRU may be (pre)configured to stop monitoring for the disabled events and/or to stop EBI reporting after a (pre)configured time duration after receiving the disabling indication. The WTRU may be (pre)configured to stop monitoring for the disabled events and/or to stop EBI reporting right after receiving the disabling indication.

After receiving the enabling indication, the WTRU may determine and/or expect that the reserved EBI reporting occasions are included in the (e.g., following, subsequent, upcoming, etc.) scheduled CG-PUSCH and/or DG-PUSCH occasions.

The configuration information regarding the reserved EBI reporting occasions may include one or more example parameters and/or configurations including time resources, frequency resources, guard bands, EBI reporting occasion type, comb configuration, repetition, priority level, codepoints, PUSCH types to include EBI reporting occasions, channel coding configurations, and carrier configuration, for example.:

For the time resources, by way of example, the time resources to be used for EBI reporting occasions may be indicated based on the number of symbols, the starting symbol, the end symbol, etc. For example, the symbols to be used for the EBI reporting occasions may be indicated based on a symbol offset value from the beginning of the slot. In another example, the symbol to be used as the EBI reporting occasion may be indicated as the symbol offset value from the end of the slot (e.g., the last symbol). In another example, the symbol to be used for the EBI reporting occasion may be indicated based on another configured symbol and/or reference point, for example, the symbol after, following, and/or next to the first, second, or third, DM-RS symbol in the slot, and so forth. In an example, the time resources may be configured with respect to a single slot boundary (e.g., within 14 OFDM symbols).

In an example, the WTRU may be (pre)configured with one or more sets of time resources (e.g., symbols) to be used for the EBI reporting occasion, where the WTRU may receive an indication including an index to the set of symbols to be used. In an example, the WTRU may receive a first index corresponding to the symbol number (e.g., within PUSCH a slot and/or a PUSCH occasion) where the EBI reporting occasion is configured; the WTRU may receive a second index corresponding to more than one symbol (e.g., within a PUSCH slot and/or a PUSCH occasion) where the EBI reporting occasions are configured, and so forth.

For the frequency resources, by way of example, for example, the frequency resources to be used as the reporting resources may be indicated based on the number of REs, the starting RE, the last RE, resource blocks (RB), resource blocks groups (RBG), etc. For example, the REs and/or RB to be used for sending the reports and/or indications may be explicitly indicated as the REs or RBs within one or more RBs or RBGs. For example, the REs and/or RB may be explicitly indicated via bitmap indication or pattern indication as the REs or RBs within one or more RBs or RBGs. In another example, the REs to be used for sending the reports and/or indications may be indicated implicitly and based on another configured RE, reference signal, indication, etc. For example, the REs may be configured to be similar to the REs used for DM-RS transmission. In another example, the REs may be configured to be similar to the REs used for HARQ-ACK transmission, etc. In an example, the frequency resources may be configured with respect to a single resource block (RB) (e.g., within 12 Res and/or subcarrier spacing).

In another example, the WTRU may be configured to use all or a portion on an RB corresponding to one or more OFDM symbols for sending the reports and/or indications. That is, for example, the WTRU may use all (e.g., 12) REs, the lowest (e.g., m) REs, the middle (e.g., n) REs, the highest (e.g., k) REs, etc. in the corresponding OFDM symbol for sending the EBI reports. In another example, a subset of Res within an RB may be configured to be used for EBI report occasions.

In an example, the WTRU may be (pre)configured with one or more sets of frequency resources (e.g., REs) to be used for the EBI reporting occasion, where the WTRU may receive an indication including an index to the set of (pre)configured REs to be used. In an example, the WTRU may receive a first index corresponding to the REs (e.g., within an RB) where the EBI reporting occasion is configured; the WTRU may receive a second index corresponding to a (pre)configured subset of REs (e.g., within an RB) where the EBI reporting occasions are configured, and so forth.

For the guard-bands, by way of example, the WTRU may determine, be configured, and/or indicated to consider zero padding, guard-band, etc. in one or more lowest and/or highest configured REs for sending the EBI reports in the configured and/or indicated EBI report occasions.

For the EBI reporting occasion type, by way of example, the WTRU may be configured and/or indicated with one or more EBI reporting occasion types. The WTRU may determine one or more modes of operation based on the EBI reporting occasion type. For example, the WTRU may determine the multiplexing method for multiplexing the EBI reporting in the PUSCH, the codepoints length, the mechanism in case of no EBI to be reported, based on the EBI reporting occasion type.

For the comb configuration, by way of example, the WTRU may determine, be configured, and/or indicated to consider a comb pattern in frequency resources (e.g., REs) configured to be used for EBI report occasions. That is, for example, within an RB, one out of every RE may be used for EBI report occasions. For example, if the comb value indicates a first value (e.g., m), the WTRU may start from the first (e.g., lowest) RE in the corresponding RB and use one out of every m REs within the RB.

For the repetition, by way of example, the WTRU may be configured with repetition across configured EBI reporting occasions in a PUSCH slot and/or a PUSCH occasion. That is, the WTRU may repeat the EBI indication, report, and/or codepoint in all configured EBI report occasions within a PUSCH slot and/or a PUSCH occasion. In another example, the WTRU may determine, be configured, and/or indicated to repeat the EBI report, indication, and/or codepoint in a configured and/or indicated subset of available EBI report occasions within a PUSCH slot and/or a PUSCH occasion.

For the priority level, by way of example, the WTRU may be configured with priority level for the configured EBI reporting occasions. As such, the WTRU may consider the configured priority levels in case of collisions or overlapping with higher or lower priority UL transmissions. In an example, the WTRU may be configured with a first priority level for a first EBI reporting occasion, a second priority level for a second EBI reporting occasion, etc. In another example, the WTRU may be configured with a first priority level for all the EBI reporting occasion of the first EBI reporting occasion type; the WTRU may be configured with a second priority level for all the EBI reporting occasion of the second EBI reporting occasion type, and so forth.

For the codepoints, by way of example,, a WTRU may be configured with one or more codepoints for indicating different events and/or indications in the configured EBI reporting occasions, where the codepoints (throughout the disclosure) may imply hard-coded EBI information bits, a set of EBI coded bit fields, pre-defined or (pre-)configured EBI message types, and/or multiple different EBI codepoints, etc. In an example, the codepoints may be based on binary sequences (e.g., in time-domain). In another example, the codepoints may be based on (e.g., OFDM-based) sequences, e.g., Zadoff Chu (ZC)-sequences, computer-generated sequences, M-sequences, Gold sequences, etc. In another example, the codepoints may be indicated based on a bitmap indication, where each bit may be associated with a (pre)configured codepoint. For example, if a first bit within the bitmap has a first value (e.g., value one), this may indicate that a first codepoint associated with the first bit and the event associated with the first codepoint may be triggered. In another example, if a second bit within the bitmap has a second value (e.g., value zero), this may indicate that a second codepoint associated with the second bit and the event associated with the second codepoint may not be triggered.

For the PUSCH types to include EBI reporting occasions, by way of example, the WTRU may receive, be configured, and/or indicated with PUSCH types to include configured EBI reporting occasions. In an example, the WTRU may receive configuration information to enable and/or allow or disable considering EBI reporting occasions in a first type PUSCH; the WTRU may receive configuration information to enable and/or allow or disable considering EBI reporting occasions in a second type PUSCH, and so forth. In an example, the first type PUSCH may be PUSCH occasions configured based on Type 0 frequency-domain resource allocation (FDRA); the second type PUSCH may be PUSCH occasions configured based on Type 1 frequency-domain resource allocation (FDRA), and so forth.

For the channel coding configurations, by way of example, the WTRU may receive, be configured, and/or indicated with one or more error control coding methods, including different coding rates, and so forth. The WTRU may use the configured error control coding mechanisms for coding the EBI codepoints before multiplexing the codepoints in the EBI reporting occasions. In an example, the error control coding may be based on polar coding, LDPC coding, Manchester coding, etc.

For the carrier configuration, by way of example, the WTRU may receive, be configured, and/or indicated with one or more indications on the carriers for which the events monitoring and/or EBI reporting occasions may be enabled. In an example, the WTRU may be operating based on carrier aggregation, single-cell multi-carrier mechanism, etc. That is, the WTRU may determine, be configured, and/or indicated to operate based on more than one carrier. The frequency resource used and/or determined for the events monitoring and/or EBI reporting occasions may be referred to as Bandwidth Part (BWP), subband, frequency band, carrier, and/or frequency resource. The carrier may include but not limited to a primary cell, a master node, default cell, cell in coverage layer, NTN cell, TN cell, primary carrier, and/or any type of transmission point.

In an example, the WTRU may receive one or more first indications on the first carriers for which the WTRU may monitor for the configured events. In another example, the WTRU may receive one or more second indications on the second carriers for which the WTRU may be configured with EBI reporting occasions. In an example, the WTRU may be configured to monitor for one or more of the configured events in a subset of first configured carriers, in all of the configured carriers, or in a single first carrier. In another example, the WTRU may be configured to determine the EBI reporting occasions in a subset of second configured carriers, in all of the configured carriers, or in a single second carrier. For example, the WTRU may consider the reserved EBI reporting occasions only in the PUSCH occasions that may be scheduled in the configured second carriers. The first and second configured carriers may be the same or different.

In an example, the WTRU may be configured to monitor for the events in a first configured carrier, where the WTRU may be configured to send EBI reporting in the EBI reporting occasions in the same first carrier, for which the events may be triggered. In another example, the WTRU may be configured to monitor for the events in a first configured carrier, where the WTRU may be configured to send EBI reporting in the EBI reporting occasions in a different second carrier. In another example, the WTRU may be configured to monitor for the events in a first set of configured carriers, where the WTRU may be configured to send EBI reporting in the EBI reporting occasions in a second carrier.

In an example, the WTRU may determine, be configured, and/or indicated to indicate the carrier for which the event associated with the reported EBI was triggered. In an example, the WTRU may use a codepoint associated with the corresponding carrier. In another example, the WTRU may indicate the corresponding carrier via a separate indication. In another example, the WTRU may indicate whether the carrier for which the event was triggered may be the same as or different from the carrier on which the EBI reporting is being transmitted. For example, the WTRU may send a flag indication as part of EBI reporting, where a first value (e.g., zero) may indicate that the carrier; a second value (e.g., one) may indicate that the carrier with the detected event may be different from the carrier with EBI transmission.

In the absence of indications on the carrier configurations regarding EBI reporting, the WTRU may consider all configured carriers for monitoring the events and/or EBI reporting occasions.

EBI reporting occasions may occur in transportblock (TB) processing over multi-slot PUSCH (TBoMS). A PUSCH may be configured and/or scheduled to be transmitted over multiple slots, for example as in TBoMS. In TBoMS, TB processing over multi-slot PUSCH may be supported. That is, the TBs may be configured and/or scheduled based on multiple slots and transmitted over multiple slots. In an example, in case of TBoMS, a WTRU may be configured and/or indicated with EBI reporting occasions only in one of the slots associated with the configured and/or scheduled TBoMS PUSCH. For example, the WTRU may be configured and/or indicated to consider the EBI reporting occasions only in the first slot, in the second slot, in the m-th slot, and/or in the last slot associated with a TBoMS PUSCH. In another example, the WTRU may be configured and/or indicated to consider the EBI reporting occasions in all of the configured and/or scheduled slots associated with a TBoMS PUSCH. In another example, the WTRU may be configured and/or indicated to consider the EBI reporting occasions in a subset of the configured and/or scheduled slots associated with a TBoMS PUSCH occasion, where the subset of slots may be indicated via explicit slot indexes, bitmap indication, pattern index indication, etc. For example, the WTRU may receive a bitmap indication, where each bit may correspond to a slot in the TBoMS configuration. As such, a bit including a first value (e.g., value zero) may indicate that the corresponding slot may not include reserved EBI reporting occasions, and that slot may not be used for EBI reporting. A bit including a second value (e.g., value one) may indicate that the corresponding slot may include reserved EBI reporting occasions, and that slot may be used for EBI reporting. In another example, a WTRU may be (pre)configured with a set of slot patterns for the TBoMS mechanism, where different slot patterns may be indexed, for example in an ascending order. As such, the WTRU may receive an indication including an index to the set of (pre)configured slot patterns, where the WTRU may determine the slots that include the reserved EBI reporting occasions and the slots that do not include the reserved EBI reporting occasions, accordingly.

In an example where the EBI reporting configuration includes indications on the repetition of the EBI reporting, the WTRU may receive one or more indications on whether the repetition of the EBI reporting can be done in the other slots in the TBoMS mechanism. In an example, the WTRU may be configured to use only the available and/or configured reserved EBI reporting occasions in the first slot in the TBoMS mechanism for repetition of the EBI reports. In another example, the WTRU may be configured to use the available and/or configured reserved EBI reporting occasions in all the configured and/or indicated slots in the TBoMS mechanism for repetition of the EBI reports.

The EBI reporting occasions may be determined based on WTRU capability. In an example, the configuration information, parameters, and/or indications on the resources to be used for EBI reporting occasions may be (pre)configured (e.g., via SIB, RRC, MAC-CE, DCI, etc.). In another example, there may be different types EBI reporting occasions. The first type of EBI reporting occasions may be for the low-end WTRUs with limited processing or CPU load capacity; the second type of EBI reporting occasions may be for high-end WTRUs with extended processing or CPU load capacity; the third type of EBI reporting occasion may be for other WTRUs. As such, the WTRU may implicitly determine to use one or more of the (pre)configured and/or indicated configurations and/or parameters based on WTRU capability, WTRU's CPU load, etc. In an example, the WTRU may determine to use the first type EBI reporting occasions, if WTRU is a low-end WTRU with low processing and/or CPU load capabilities. In an example, the first type may include the EBI reporting occasions in the symbols closer to the end or at the end of slots. In another example, the first type may include the EBI reporting occasions through all REs within an RB. In another example, the second type may include more than one EBI reporting occasions on more than one symbol within a PUSCH slot and/or a PUSCH occasion, on a configured subset of REs, etc.

The WTRU may send a report (e.g., as part of a handshake, e.g., to a gNB) indicating WTRU capability and the EBI reporting occasion types supported by the WTRU for EBI reporting.

In an example, the WTRU may be configured to use one EBI reporting occasion type (semi-statically), e.g., either the first type EBI occasions (with reserved REs for EBI reporting) or the second type EBI occasions (without reserved REs for EBI reporting), or a third type EBI occasions (if configured), and so on. The WTRU may receive a switching command to switch to apply one type to another type.

In an example, a WTRU may be configured with one or more types of EBI reporting occasions in a PUSCH occasion (e.g., in a PUSCH slot), where the WTRU may use the different EBI reporting occasion types based on one or more conditions. The different EBI reporting occasion types may be associated with different configuration information, priorities, parameters, and/or settings, as described herein. For example, a PUSCH occasion (e.g., a PUSCH slot) may be configured to include only a single EBI reporting occasion, multiple EBI reporting occasions, and so forth.

In an example, a WTRU may be configured with one or more EBI reporting occasions (e.g., in a PUSCH slot and/or a PUSCH occasion), where the configured EBI reporting occasions may all be of only one EBI reporting occasion type. In another example, the WTRU may be configured with more than one EBI reporting occasions (e.g., in a PUSCH slot and/or a PUSCH occasion), where the configured EBI reporting occasions may be configured based on different EBI reporting occasion types.

For example, a WTRU may be configured with a first EBI reporting occasion type and a second EBI reporting occasion type. In an example, the WTRU may receive the EBI reporting occasion types (e.g., explicitly), e.g., from a gNB, e.g., via RRC, MAC-CE, DCI, etc. In an example, the WTRU may receive configuration information and/or indications on the EBI reporting occasion type to be used for EBI reporting occasions, e.g., as part of EBI reporting configuration information. The WTRU may receive the indication via PDSCH scheduling DCI, the PUSCH scheduling DCI, MAC-CE, or RRC. In another example, the WTRU may receive the indication on the EBI reporting occasion type to be used as part of the EBI reporting enabling indication. In another example, the WTRU may receive the indication on the EBI reporting occasion to be used as part of the event activation indication. In another example, the WTRU may (e.g., implicitly) determine the EBI reporting occasion type, for example based on one or more conditions. For example, the WTRU may be configured to consider the EBI reporting occasions closer to the beginning of a slot to be the first EBI reporting occasion type, e.g., before n-th symbol. The WTRU may be configured to consider the EBI reporting occasions configured closer to the end of the slot, in time, to be of the second EBI reporting occasion type.

In an example, a WTRU may determine, be configured, and/or indicated to operate based on one or more modes of operation based on the EBI reporting occasion types. In an example, one or more of the following example modes of operation may apply including with or without Res, multiplexing method, and codepoint length.

For the with or without reserved Res, by way of example, the WTRU may determine, be configured, and/or indicated to consider the REs configured with a first EBI reporting occasion type as reserved resources. The reserved resources associated with the first EBI reporting occasion type may be indicated via explicit indication of the REs, an index to a set of (pre)configured RE patterns, a RE level bitmap (e.g., within a symbol) (e.g., with 1RE granularity), etc. The WTRU may be configured that the REs indicated for the first EBI reporting occasion type may not be available for PUSCH. As such, when the WTRU detects an event, the WTRU may transmit the codepoint corresponding to the triggered event in the configured first EBI reporting occasion type. In case no event is detected, the WTRU may send the empty REs or the WTRU may send one or more (pre)configured, dummy, and/or default codepoints in the reserved REs configured as the EBI reporting occasion type.

In another example, the REs corresponding to the second EBI reporting occasion type may not be reserved for EBI reporting. As such, the WTRU may determine, be configured, and/or indicated to send PUSCH data in the REs configured as the second EBI reporting occasion type, in case no EBI is to be reported.

For the multiplexing method, by way of example, the WTRU may be configured to multiplex the EBI reporting codepoints based on a first multiplexing pattern (e.g., rate matching) in case the WTRU sends the EBI reporting in a first EBI reporting occasion with the first type. The WTRU may be configured to multiplex the EBI reporting codepoints based on a second multiplexing pattern (e.g., puncturing) in case the WTRU sends the EBI reporting codepoints in the second EBI reporting occasion type. That is, in case the WTRU uses the second EBI reporting occasion type, the codepoint carrying the EBI reporting may be multiplexed by puncturing PUSCH.

For the codepoint length, by way of example, the WTRU may determine, be configured, and/or indicated to use the configured long codepoints to be transmitted in the first EBI reporting occasion type. The WTRU may be configured to send the configured short codepoints in the second EBI reporting occasion type. In another example, the codepoints transmitted in the first and second EBI reporting occasions may have the same length.

In an example, a WTRU may determine the EBI reporting occasion type to be used for EBI reporting, based on one or more conditions. For example, in case the WTRU is configured with more than one EBI reporting occasions with different types, the WTRU may determine, be configured, and/or indicated to select the EBI reporting occasion to be used for the EBI reporting based on one or more conditions including time of the event, channel conditions, interference conditions, PUSCH length and codepoint length.

For the time of the event, by way of example, if the event triggering the EBI reporting was triggered a delta-time in advance before the start of the slot including the PUSCH transmission, the WTRU may use the first EBI reporting occasion type. Otherwise, if the event is triggered within the delta-time before the start of the PUSCH slot, the WTRU may use the second EBI reporting occasion type.

For the channel conditions, by way of example, if the measured channel quality parameters (e.g., RSRP, SINR, RSRQ, RSSI, etc.) is lower than a configured threshold, the WTRU may be configured and/or indicated to use the first EBI reporting occasion type. In another example, if the evaluated BLER is higher than a configured corresponding threshold value, the WTRU may use the first EBI reporting occasion type. Otherwise, if the measured channel conditions are higher than the configured threshold, the WTRU may use either the first or the second EBI reporting occasion types. In another example, if the evaluated BLER is lower than the configured corresponding threshold value, the WTRU may use either of the EBI reporting occasion types.

For interference conditions, by way of example, if the measured interference (e.g., CLI) is higher than a configured threshold, the WTRU may use the first EBI reporting occasion type. Otherwise, if the measured interference (e.g., CLI) is lower than the configured threshold, the WTRU may use the second EBI reporting occasion type.

For the PUSCH length, by way of example, in case of a short PUSCH, the WTRU may use the second EBI reporting occasion type. Otherwise, if the PUSCH is not of a short type, the WTRU may use either of the first or the second EBI reporting occasion type.

For the codepoint length, by way of example, if the configured codepoint to be transmitted due to a triggered event is a long codepoint, the WTRU may use the first EBI reporting occasion type. Otherwise, if the codepoint is a short codepoint, the WTRU may use either of the first or the second EBI reporting occasion type. In an example, the WTRU may be configured to use zero-padding or send empty REs in case the number of reserved REs is longer than the codepoint's length.

As set forth, at 630, At 630, method 600 includes monitoring for at least one event. This monitoring may include triggering events, such as an L1-event, for example. The monitoring for at least one event may include at least one of strong CLI, high hypothetical block error rate (BLER), low reference signal received power (RSRP), low signal-to-noise ratio (SNR), beam reporting, or LTM events. The monitoring for at least one event is based on at least one of one or more channel or interference measurements, or one or more reference signals. One or more reference signals may include SSB, CSI-RS, PDSCH DM-RS, PDCCH DM-RS, SRS, and the like, for example.

In an example, a WTRU may determine to send EBI reports on one or more EBI reporting occasions based on one or more conditions. For example, the WTRU may receive, be configured, and/or indicated with one or more configuration information on one or more EBI reporting occasions in one or more scheduled, and/or configured PUSCH transport blocks (TBs). The WTRU may be configured and/or indicated with one or more events (e.g., L1 or L2 events) that may trigger sending EBI reports. The WTRU may receive the configuration information and/or indications on EBI reports, e.g., from a gNB, e.g., via RRC, MAC-CE, DCI, etc.

In an example, a WTRU may use the determined, configured, and/or indicated EBI reporting occasions for sending one or more indications, codepoints, etc. in case one or more events are triggered. The WTRU may determine, be configured, and/or indicated with one or more events, and corresponding configuration information. The configuration information may include one or more threshold values, time window configurations, power control parameters, and so forth. The configuration information may include the priority level for the events, where a first event may have a higher priority than a second event. As such, if the first and the second events need to be reported based on EBI reporting, the WTRU may prioritize reporting the codepoint corresponding to the event with the higher priority.

In an example, the WTRU may determine, be configured, and/or indicated with one or more of the following events, based on which the WTRU may trigger EBI reporting:

In an example, a WTRU may determine, be configured, and/or indicated to trigger EBI reporting in case one or more L1-events based on channel and/or radio link quality parameter L1 measurements are triggered. In an example, the WTRU may receive configuration information on the L1-events based on quality parameters to trigger EBI reporting via SIB, RRC, MAC-CE, DCI, etc. In an example, the quality parameters may include SINR, RSRP, RSSI, RSRQ, hypothetical BLER, etc. The L1 measurements may be based on a measurement over a short time period (e.g., one slot, within a slot, one or more OFDM symbols within a slot).

In an example, the WTRU may measure the quality parameters based on one or more reference signals (RSs) embedded and/or multiplexed in the received PDSCH and/or received as part of the received PDSCH. In an example, the WTRU may measure the quality parameters based on received PDSCH DM-RS. The WTRU may be configured with one or more DM-RS as part of the received PDSCH. The DM-RS may have different antenna ports. In an example, the WTRU may measure the received power (e.g., RSRP), signal strength (e.g., RSSI), etc. based on the received DM-RSs having the same antenna port in the corresponding time instances. In another example, the WTRU may average the L1 measurements and/or use one or more formulas, functions, and/or equations to evaluate hypothetical BLER based on the L1 measurements.

In another example, the WTRU may measure one or more of the quality parameters L1 measurements based on one or more received reference signals. The reference signals may include but not limited to SSB, CSI-RS, Phase Tracking Reference Signal (PT-RS), Tracking Reference Signal, (TRS), SRS, sidelink-CSI-RS, etc.

The WTRU may determine and/or trigger an L1-event based on channel and/or radio link quality based on one or more of the following example events: L1 measurements on SINR, RSRP, RSRQ, RSSI, etc. being lower than a configured, determined, and/or indicated corresponding threshold value; evaluated hypothetical BLER based on L1 measurements being higher than a configured, determined, and/or indicated corresponding threshold; and the like.

The L1 measurements of quality parameters may be considered as CSI reporting quality and configured as a part of CSI reporting setting. In an example, the L1-events (in addition to corresponding threshold values) leading to triggering EBI reporting may be considered as CSI reporting quality and configured as a part of CSI reporting setting, e.g., L1-RSRP-EBI, L1-SINR-EBI, L1-RSRQ-EBI, L1-RSSI-EBI, L1-BLER-EBI, etc.

In an example, a WTRU may determine, be configured, and/or indicated to trigger EBI reporting in case one or more L1 interference events are triggered. A WTRU may be configured, determined, and/or indicated to perform a measurement of Interference Received Signal Strength Indicator (I-RSSI) in a given time period, wherein the given time period may be one or more slots, OFDM symbols, resource blocks (RBs), and/or resource elements (REs). The interference RSSI which may be measured in a given time and frequency resource may be referred to as L1-I-RSSI, short-term I-RSSI, aperiodic I-RSSI, and so forth. The interference may be based on inter-cell interference, inter-carrier interference, cross-link interference (CLI), inter-layer interference, intra-cell interference, intra carrier interference, and so forth.

One or more I-RSSI types may be used and a WTRU may be configured to perform one or more I-RSSI types, wherein a first I-RSSI type may be based on a measurement over a long time period (e.g., more than one slot) and the measurement is reported via a higher layer signaling (e.g., RRC, MAC) ; and a second I-RSSI type may be based on a measurement over a short time period (e.g., one slot, within a slot, one or more OFDM symbols within a slot) and the measurement is reported via a L1 signaling in one or more EBI reporting occasions. I-RSSI may be interchangeably used with RSRP, RSRQ, and SINR.

In an example, a WTRU may be configured with a set of time and frequency resources to measure I-RSSI, wherein the time and frequency resources for L1-I-RSSI measurement may be referred to as I-RSSI Measurement Resource (CRMR).

CRMR may be a resource configured, determined, or defined with one or more of properties including a set of muted REs in a downlink resource, a set of REs not scheduled or used for the WTRU measuring CRMR, a set of REs located in an RB, one or more reference signals, and location within a scheduled resource.

The set of muted REs in downlink resource (e.g., CG or DG PDSCH), wherein the muted REs may be rate-matched around or punctured for downlink reception and/or uplink transmission. The set of muted REs may have a same pattern (e.g., same time or frequency location) in each RB. The set of muted REs may have a different pattern based on the RB location. For example, a first pattern may be used for the RBs located in an edge of the scheduled RBs and a second pattern may be used for the RBs located in a center of the scheduled RBs. The first pattern and the second pattern may have a different number of muted REs. The muted REs may be in a form of zero-power CSI-RS (ZP-CSI-RS)

The set of REs may be located in an RB which may be configured or determined as guard band (or guard RB). A guard band (or guard RB) may be located in between uplink and downlink resources. A WTRU may skip receiving or transmitting a signal in guard band.

One or more reference signals may be used, such as DMRS, SRS, sidelink CSI-RS, for example. Located within a scheduled resource may be used, such as scheduled PDSCH RBs, for example.

CRMR may be configured commonly for a set of WTRUs (e.g., WTRUs in proximity). For example, a gNB may configure a CRMR for a group of WTRUs, wherein the group of WTRUs may share one or more of following: a group-ID to receive a DCI (e.g., a group-RNTI); a zone-ID, wherein the zone-ID may be determined based on a geographical location of the WTRU (e.g., GNSS); and WTRUs paired for sidelink unicast (or groupcast) transmission

In an example, the L1-I-RSSI measurement (including CRMR resource) may be considered as CSI reporting quality and configured as a part of CSI reporting setting.

In an example, a WTRU may determine, be configured, and/or indicated to trigger EBI reporting in case one or more beam quality L1 events are triggered. The WTRU may measure one or more quality parameters based on a first active beam. The WTRU may measure one or more quality parameters based on one or more second candidate beams. The quality parameters may include L1-RSRP, L1-RSSI, L1-RSRQ, L1-SINR, etc. The L1 measurements may be based on a measurement over a short time period (e.g., one slot, within a slot, one or more OFDM symbols within a slot, etc.).

The WTRU may determine to trigger beam quality EBI reporting in case one or more of the following example events are triggered: quality of the first beam is worse than a configured and/or indicated threshold. That is, the L1 measurements on the quality parameters based on the first beam are lower than the corresponding threshold; quality of at least one on the candidate second beams becomes a threshold value better than the quality of the active first beam. For example, the L1 measurements on the quality parameters based on a second candidate beam is higher than the L1 measurements on the quality parameters based on the first beam; quality of at least a second candidate beam is better than a configured and/or indicated threshold. That is, the L1 measurements on the quality parameters based on the second candidate beam are higher than the corresponding threshold; and the like.

In an example, the L1-beam-EBI measurement (including first and second beam resources'configurations) may be considered as CSI reporting quality and configured as a part of CSI reporting setting.

In an example, a WTRU may determine, be configured, and/or indicated to trigger EBI reporting in case one or more LTM events are triggered. The WTRU may measure one or more quality parameters based on a first serving cell. The WTRU may measure one or more quality parameters based on one or more second candidate non-serving cells. The quality parameters may include L1-RSRP, L1-RSSI, L1-RSRQ, L1-SINR, etc. The L1 measurements may be based on a measurement over a short time period (e.g., one slot, within a slot, one or more OFDM symbols within a slot, etc.).

The WTRU may determine to trigger LTM EBI reporting in case one or more of the following example events are triggered: beam of the first serving cell becomes worse than an absolute threshold; beam of at least a candidate second cell becomes amount of offset better than beam of the first serving cell; beam of at least a candidate second cell becomes better than absolute threshold; beam of the first serving cell becomes worse than absolute threshold1 and beam of at least a candidate second cell becomes better than another absolute threshold2; and the like.

In an example, the L1-LTM-EBI measurement (including first and second cells'configurations) may be considered as CSI reporting quality and configured as a part of CSI reporting setting.

A WTRU may receive an indication from the network on the congestion state at the network, such as user-plane (UP) events. The network may determine the congestion state based on the number of WTRUs currently being served by the respective gNBs, the number of WTRUs it is expecting to serve in the upcoming future (E.g., WTRUs in INACTIVE state), and the scheduling needs of the traffic of the respective WTRUs. The indication may include activation of WTRU monitoring for user-plane events and reporting a potential congestion, overflow, unfulfilled scheduling request (SR), etc., for example via EBI reporting.

In an example, a WTRU may determine, be configured, and/or indicated to report user-plane events via EBI reporting occasions in case an L2 user-plane event is triggered based on one or more WTRU's user-plane traffic conditions. In an example, one or more of the following may apply: buffer status and/or buffer level monitoring at the WTRU: E.g., if the WTRU experiences buffer overflow, if buffer levels at WTRU are filled at >X% (e.g., X=80) continuously (e.g., for a preconfigured time window), the time that the traffic spends in any of the L2 buffers (e.g., PDCP buffer, MAC buffer, etc.), time spent in buffer calculation, etc. ; unanswered and/or unfulfilled SR and/or BSR requests: the WTRU may determine that there is a congestion, resulting in EBI reporting; partially fulfilled BSR requests: e.g., if WTRU get an UL grant that is not sufficient to send the indicated traffic volume level in the BSR., indication from application: e.g., the WTRU may receive an indication from the application in the application layer on the upcoming traffic. For example, a WTRU sending XR traffic in the UL may determine that it may experience congestion in a current and/or upcoming time window; and the like.

In an example, the L2-UP-EBI monitoring may be considered as CSI reporting quality and configured as a part of CSI reporting setting. The activation of UP events reporting may be received via RRC, MAC-CE, DCI, etc.

In an example, a WTRU may determine, be configured, and/or indicated to trigger “HARQ-NACK” EBI reporting in case the measured hypothetical BLER corresponding to the DM-RS of a received PDSCH is higher than a configured BLER threshold value. The WTRU may be configured with one or more DM-RS as part of the received PDSCH. The DM-RS may have different antenna ports. In an example, the WTRU may measure the received power (e.g., RSRP), signal strength (e.g., RSSI), etc. based on the received DM-RSs having the same antenna port in the corresponding time instances. In another example, the WTRU may average the L1 measurements and/or use one or more formulas, functions, and/or equations to evaluate hypothetical BLER based on the L1 measurements. In case the evaluated hypothetical BLER is higher than the configured BLER threshold, the WTRU may determine that the received PDSCH may not be decodable and may result in HARQ-NACK. As such, the WTRU may send the codepoint corresponding to the “HARQ-NACK” EBI for indicating this event. In an example, the “HARQ-NACK” EBI may be based on an enhanced one-shot codebook corresponding to the received PDSCH.

The WTRU may receive indications on the activation of one or more events that may trigger EBI reporting. The indication may include one or more configuration information, for example the activation starting time, the activation time duration, the activation end time, the activated carriers, the activated beam resources, and so forth. In an example, after receiving the configurations, the WTRU may trigger EBI reporting via EBI reporting occasions if the configured event is detected after the activation starting time, during the activation time window, and/or before activation end time; the WTRU may trigger EBI reporting if the configured event is detected in one or more of the configured activated carriers; the WTRU may trigger EBI reporting if the configured event is detected based on one or more of the configured activated beam resources, and so forth. The WTRU may add the activated events to a list of activated events for triggering the EBI reporting.

Alternatively, the WTRU may receive indications on the events that no longer trigger EBI reporting. The indication may include one or more configuration information, for example the deactivation starting time, the deactivation time duration, the deactivation end time, the deactivated carriers, the deactivated beam resources, and so forth. In an example, after receiving the configurations, the WTRU may skip triggering EBI reporting via EBI reporting occasions if the configured event is detected after the deactivation starting time, during the deactivation time window, and/or before deactivation end time; the WTRU may skip triggering the EBI reporting if the configured event is detected in one or more of the configured deactivated carriers; the WTRU may skip triggering the EBI reporting if the configured event is detected based on one or more of the configured deactivated beam resources, and so forth. The WTRU may remove the deactivated events from the list of activated events for triggering the EBI reporting.

Herein, a beam resource may consist of a TCI state, CSI-RS, SSB, DL reference signals for downlink, an SRS resource or TCI state for uplink.

In an example, a WTRU may receive one or more indications and/or corresponding configuration information on the events to add or remove from the list of events triggering the EBI reporting. The WTRU may receive the indications, for example via RRC, MAC-CE, DCI, etc. In an example, the WTRU may receive the indications on the activation and deactivation of the events via WTRU-specific signaling, group-common signaling via group-based DCI and/or group-based broadcasted signaling, cell-common signaling via cell-specific broadcasted signaling, and so forth. The WTRU may receive the indications based on one or more of the following example mechanisms:

In an example, a WTRU may be (pre)configured with a table and/or a list of events that may trigger EBI reporting, such as explicit event indication. The WTRU may be configured and/or indicated with an index or a codepoint corresponding to each entry in the table and/or list of events. For example, the WTRU may receive the configuration information on the table and/or list of events via RRC, MAC-CE, DCI, etc. For example, the events in the list and/or table may include L1 or L2 events. In an example, each entry of the table and/or list may correspond to an event, for example including but not limited to low channel conditions event, low measured L1-RSRP, high measured BLER, strong measured interference, LTM events, beam quality events, UP-events, and so forth, as described herein.

The WTRU may receive one or more indications including index(es) to one or more of the events from the table and/or list of events to be added in the list of activated events for EBI reporting. Alternatively, the WTRU may receive one or more indications including index(es) to one or more of the events from the table and/or list of events to be removed in the list of activated events for EBI reporting.

In an example, a WTRU may be (pre)configured with a set of EBI-reporting-based CSI quality parameters, based on which the WTRU may determine to measure, monitor, and/or trigger one or more EBI reporting. In an example, one or more EBI-reporting-based (e.g., X-EBI) measurement qualities may be considered as CSI reporting quality and configured as part of CSI reporting configuring setting. The EBI-reporting-based CSI quality parameters configurations (e.g., X-EBI) may also include one or more configuration information on measuring time window, measurement quantities, threshold values, etc. (e.g., CRMR resources). In an example, the X-EBI may include L1-RSRP-EBI, L1-SINR-EBI, L1-RSRQ-EBI, L1-RSSI-EBI, L1-BLER-EBI, L1-I-RSSI, L1-beam-EBI, L1-LTM-EBI, L2-UP-EBI, etc.

The WTRU may receive, be configured, and/or indicated with one or more EBI-reporting-based quality parameters as part of CSI report configurations. After receiving CSI report configuration including EBI-reporting-based quality parameters and/or activation of one or more CSI report configuration including EBI-reporting-based quality parameters, the WTRU may measure one or more corresponding quality parameters. The WTRU may monitor for configured events, where the WTRU may trigger EBI reporting via EBI reporting occasions, if a corresponding event is triggered.

In an example, a WTRU may be (pre)configured with a list of events that may trigger EBI reporting, where the list may be indexed, with indexes in an ascending order, such being based on bitmap indication. The WTRU may be configured and/or indicated with an index corresponding to each entry in the list of events. For example, the WTRU may receive the configuration information on the list of events and the indexes via RRC, MAC-CE, DCI, etc. For example, the events in the list may include L1 or L2 events.

The WTRU may receive one or more bitmap indications, where each bit in the bitmap may correspond to one of the entries in the list of events, based on the indexed list in the ascending order of the indexes. The size of the bitmap may correspond to the total number of events in the list. After receiving the bitmap, the WTRU may determine that the events corresponding to the bit values with a first value (e.g., value one) may be activated for EBI reporting purposes, whereas the events corresponding to the bit values with a second value (e.g., value zero) may be deactivated for EBI reporting.

As set forth, at 640, method 600 includes selecting a PUSCH instance from the scheduled one or more PUSCH instances may include selecting the closest available PUSCH instance in time to the triggering based on the monitored event. As will be described in more detail below, the closest available PUSCH instance need not be the next instance. In case an L1-event is triggered, the WTRU selects the closest available PUSCH in time. The WTRU may also determine one or more codepoints to be used for reporting the triggered event.

For selecting 640 the PUSCH resources for EBI reporting, in an example, a WTRU may determine the EBI reporting occasions to be used based on the closest EBI reporting occasions in the closest PUSCH resources, e.g., in time. This may benefit the system by simplifying the UCI in PUSCH. The WTRU may determine the closest PUSCH resources in time, based on one or more conditions. In an example, one or more of time offset of the closest PUSCH, carrier of the closest PUSCH, TCI state of the closest PUSCH, and based on EBI reporting occasion type.

For the time offset of the closest PUSCH, time offset until the closest PUSCH and event overlapping with ongoing PUSCH may be considered, For the time offset until the closest PUSCH, for example, the WTRU that is configured with one or more CG or DG PUSCH occasions may select the closest PUSCH to be used for EBI reporting. The WTRU may select the first PUSCH occasion as the closest PUSCH occasion for which the time offset till the beginning of the first PUSCH is the shortest. In an example, the WTRU may measure, calculate, and/or determine the time offsets till one or more CG or DG PUSCH occasions that are configured with enabled EBI reporting occasions. In an example, in case the PUSCH is configured over multiple slots and/or TBoMS, the WTRU may measure, calculate, and/or determine the time offsets till the PUSCH slot that is configured with and includes enabled EBI reporting occasions. The WTRU may determine the time offsets based on time units (e.g., msec, microsec, etc.) or based on number of symbols, slots, subframes, etc. For example, the WTRU may determine that there is a first time offset till the closest first PUSCH occasion and/or PUSCH slot with enabled EBI reporting occasion, and there is a second time offset till the closest second PUSCH occasion and/or PUSCH slot with enabled EBI reporting occasion, and so forth. As such, the WTRU may select the first PUSCH occasion for the EBI reporting in case the first time offset is shorter than the second time offset and all the other time offsets, and so forth.

For event overlapping with ongoing PUSCH, for example, a WTRU may detect a triggered event while transmitting an ongoing CG or DG PUSCH with enabled EBI reporting occasions. The WTRU may select the ongoing PUSCH as the closest PUSCH occasion, for transmitting the EBI reporting associated with the triggered event, if the event is detected within a configured time-window from the beginning of the respective PUSCH slot. In an example, the time window may be indicated and/or configured, e.g., via DCI, MAC-CE, RRC, etc. In another example, the WTRU may indicate and/or report the time window based on WTRU capabilities. In another example, the time window may be (pre)configured based on the location of the EBI reporting occasions within the PUSCH slot. That is, the WTRU may be configured with a first time window, if the EBI reporting occasion is in a first configured portion of the PUSCH slot (e.g., before n-th symbol from the beginning of the PUSCH); the WTRU may be configured with a second time window, if the EBI reporting occasion is in a second configured portion of the PUSCH slot (e.g., before m-th symbol from the beginning of the PUSCH), and so forth.

For the carrier of the closest PUSCH, the closest PUSCH is scheduled in the same carrier as active carrier and closest PUSCH is scheduled in a different carrier as the event may be used. For the closest PUSCH is scheduled in the same carrier as active carrier, in an example, the WTRU may determine that the closest PUSCH, in time, with enabled EBI reporting occasions is scheduled in the same carrier as WTRU's active carrier. The WTRU's active carrier may be the carrier where the WTRU has received and measured the PDSCH, RSs, etc. leading to the event being triggered. In this case, the WTRU may select the determined closest PUSCH for the EBI reporting.

For the closest PUSCH is scheduled in a different carrier as the event, in an example, the WTRU that has detected a triggered event may determine that one or more of the PUSCH occasions with enabled EBI reporting occasions may be scheduled in one or more different carriers than WTRU's active carrier. The WTRU's active carrier may be the carrier where the WTRU is receiving and measuring the PDSCH, RSs, etc. leading to the event being triggered. In case the time offset between the time that the event has been triggered and a first cross-carrier PUSCH occasion in larger than or equal a (pre)configured cross-carrier time threshold, the WTRU may select the first PUSCH for EBI reporting. In case the time offset between the time that the event has been triggered and a second cross-carrier PUSCH occasion in shorter than the (pre)configured cross-carrier time threshold, the WTRU may not select the second PUSCH for EBI reporting. In this case, the WTRU may select the next and/or following third closest PUSCH occasion with enabled EBI reporting occasions for reporting the EBI. For example, the third closest PUSCH occasion may be scheduled in WTRU's active carrier and/or the third closest PUSCH occasion may be cross-carrier scheduled. In an example, the WTRU may be configured and/or indicated with the cross-carrier time threshold. In another example, the WTRU may report the cross-carrier time threshold as part of WTRU's capability report.

In an example, in case the subcarrier spacing (SCS) in the different carriers are different, the WTRU may use one or more scaling coefficients and/or parameters for scaling the time offset in a similar scale for the different SCSs.

For the TCI state of the closest PUSCH, a same TCI state as the active TCI state and a different TCI state as the active TCI state may be used. For the same TCI state as the active TCI state, in an example, the WTRU may determine that the closest PUSCH, in time, with enabled EBI reporting occasions is scheduled with the same beam direction and/or TCI state as WTRU's active TCI state. The WTRU's active TCI state may be the beam direction and/or the TCI state based on which the WTRU has received and measured the PDSCH, RSs, etc. leading to the event being triggered. In an example, the WTRU may be configured with unified TCI state framework. In this case, the WTRU may select the determined closest PUSCH for the EBI reporting.

For different TCI state as the active TCI state, in an example, the WTRU that has detected a triggered event may determine that one or more of the PUSCH occasions with enabled EBI reporting occasions may be scheduled with a different TCI state and/or beam direction as the WTRU's active TCI state. The WTRU's active TCI state may be the first TCI state and/or the beam direction where the WTRU is receiving and measuring the PDSCH, RSs, etc. leading to the event being triggered.

As such, in case the time offset between the time that the event has been triggered and a first PUSCH occasion with a second TCI state is larger than or equal a (pre)configured QCL time threshold (e.g., timeDurationForQCL), the WTRU may select the first PUSCH for EBI reporting. In case the time offset between the time that the event has been triggered and a second PUSCH occasion with a third TCI state in shorter than the (pre)configured QCL time threshold, the WTRU may not select the second PUSCH for EBI reporting. In this case, the WTRU may select the next and/or following third closest PUSCH occasion with enabled EBI reporting occasions for reporting the EBI. For example, the third closest PUSCH occasion may be scheduled with the same TCI state as the first TCI state and/or the third closest PUSCH occasion may be scheduled with a fourth TCI state. In an example, the WTRU may be configured and/or indicated with the QCL time threshold. In another example, the WTRU may report the QCL time threshold as part of WTRU's capability report.

When the basis is on EBI reporting occasion type, in an example, the WTRU may determine that the closest PUSCH, in time, with enabled EBI reporting occasions may include one or more EBI reporting occasion types. In an example, the WTRU that has determined, been configured, and/or indicated to use a first EBI reporting occasion type may determine to select a first closest PUSCH occasion for EBI reporting if the first PUSCH occasion includes the first EBI reporting type. In another example, the WTRU that has determined, been configured, and/or indicated to use a second EBI reporting occasion type may determine to not select a second closest PUSCH occasion for EBI reporting if the second PUSCH occasion does not include the second EBI reporting type.

In an example, the WTRU may determine on whether to send the EBI reporting in the closest PUSCH based on one or more conditions. For example, the WTRU may send the EBI reporting in the closest PUSCH (e.g., in time), if one or more of the conditions apply.

One condition includes if the PUSCH is enabled to include the EBI reporting occasions. For example, the WTRU may receive one or more indications on whether one or more CG-PUSCH and/or DG-PUSCH are enabled to support and/or include EBI reporting occasions. In case a PUSCH is enabled, the WTRU may use the configured EBI reporting occasions in the PUSCH for EBI reporting.

Another condition includes if the carrier in which the PUSCH is scheduled is allowed and/or configured for the EBI reporting. For example, the WTRU may receive one or more indications on whether one or more carriers (e.g., in carrier aggregation, or single-cell multi-carrier framework) are enabled to support and/or include EBI reporting occasions. In case a carrier is enabled, the WTRU may use the CG-PUSCH or DG-PUSCH occasions in the carrier and the corresponding configured EBI reporting occasions in the PUSCH for EBI reporting.

Another condition may include If the EBI reporting is activated. For example, the WTRU may receive one or more indications on whether one or more events and event-based reporting for the corresponding events are activated. In case EBI reporting is activated, the WTRU may use the configured EBI reporting occasions in the PUSCH for EBI reporting.

Another condition may include if the PUSCH priority level allows EBI reporting based on the priority of the event and/or priority of the EBI reporting. For example, the WTRU may receive configuration information on the PUSCH priority levels and EBI reporting occasions priority levels. The WTRU may determine to use the PUSCH, if the EBI reporting priority is equal or more than the PUSCH priority.

As set forth, at 650, method 600 includes that the selecting an EBI reporting occasion in the selected PUSCH instance may be based on at least one of time limits, power or duplex mode. The WTRU may determine and/or select the EBI reporting occasions, and mode of operation be used for EBI reporting in the selected closest PUSCH, based on one or more of the following example conditions and scenarios:

When selecting 650 based on time limits, the time limit may be configured such that if the time offset between the triggering of the event and the selected PUSCH instance is equal to or greater than a threshold delta-time, where the threshold is based on reported WTRU capability, the method further comprises determining to use a first type EBI occasion. Alternatively, or additionally, the time limit may be configured such that if the time offset between the triggering of the event and the selected PUSCH instance is smaller than a delta-time, the method further comprises determining to use a second type EBI occasion. Alternatively, or additionally, the time limit may be configured such that if the event is detected after a configured time-window after a beginning of a slot, the method further comprises determining to use a next PUSCH instance or a next slot in TBoMS framework.

The time limit may be configured based on selected length of a PUSCH. For example, if PUSCH length <L1, determine to use a second type EBI occasions. For example, if PUSCH length >L1, determine to use a first type EBI occasion.

In an example, a WTRU may be configured with one or more EBI reporting occasions (e.g., in a PUSCH slot and/or a PUSCH occasion) in one or more different time instances (e.g., symbols). For example, the WTRU may be configured with a first EBI reporting occasion REs in the n-th symbol form the beginning of the slot; the WTRU may be configured with a second EBI reporting occasion REs in the m-th symbol form the end of the slot, and so forth.

The time limit may be based on time of events being triggered. In an example, the WTRU may detect a triggered event to be reported via EBI reporting occasions, in advance and before a configured delta-time before the start of the slot. In this case, the WTRU may use the first EBI reporting occasion type. In another example, in case the event is triggered within the delta-time before the start of the slot, the WTRU may use the second EBI reporting occasion type. In another example, in case the event is triggered during an ongoing PUSCH TB transmission (e.g., in a slot), the WTRU may use the second EBI reporting occasion type within the ongoing PUSCH, if the event is detected within a configured time-window from the beginning of the respective PUSCH slot. In case the event is triggered after the configured time-window, the WTRU may use the EBI reporting occasions in a next PUSCH, or the next slot in TBoMS framework for EBI reporting.

The time limit may be based on PUSCH length. In an example, if the PUSCH length is longer than a configured threshold, the WTRU may use either the first or the second EBI reporting occasions. Otherwise, if the PUSCH length is shorter than the configured threshold, the WTRU may be configured to use only the first or the second EBI reporting occasion.

In an example, a WTRU may determine one or more parameters for the EBI reporting based on one or more conditions with regards to the power limits. In an example, the WTRU may determine, calculate and/or evaluate the UL power for the selected PUSCH (e.g., PUSCH UL power). In an example, the WTRU may measure received power based on one or more RRM measurements (e.g., DL_RSRP), for example based on the received PDSCH (e.g., based on DM-RS), PDCCH (e.g., based on DM-RS), and/or one or more reference signals (e.g., SSB, CSI-RS, TRS, etc.).

When selecting 650 based on power, if good channel conditions exist, method 600 may further include determining to not use polar coding for the codepoint and to use first type EBI occasions. Good channel conditions may be defined as PUSCH power<P1 and/or DL_RSRP>RSRP-threshold1. For example, in good channel conditions, the WTRU may determine to use EBI reporting based on codepoints with no or very high-rate channel error coding. In an example, the WTRU may determine to use first EBI reporting occasions type in this case. In another example, the WTRU may use long codepoints for the EBI reporting.

If mediocre channel conditions exist, method 600 may further include determining to use polar coding for the codepoint. Mediocre channel conditions may be defined as P1<PUSCH power<P2 and/or RSRP-threshold2<DL_RSRP<RSRP-threshold1. For example, in mediocre channel conditions, the WTRU may determine to use EBI reporting based on codepoints with channel error coding. In an example, the WTRU may determine to use first EBI reporting occasions type in this case. In another example, the WTRU may use long codepoints for the EBI reporting.

If bad channel conditions exist, method 600 may further include determining to send the EBI with power boosting. Bad channel conditions may be defined as P2<PUSCH power<P3 and/or RSRP-threshold3<DL_RSRP <RSRP-threshold2. For example, in bad channel conditions, the WTRU may determine to use EBI reporting based on codepoints with strong and/or low-rate channel error coding. In an example, the WTRU may use short codepoints for the EBI reporting. In another example, the WTRU may use power boosting for the EBI report transmission. That is, the WTRU may determine, be configured, and/or indicated to use a first power boosting value (e.g., +X dB compared to PUSCH UL power) for the EBI transmission.

If very bad channel conditions exist, method 600 may further include determining to use repetition. Very bad channel conditions may be defined as P3<PUSCH power and/or DL_RSRP<RSRP-threshold3. For example, in very bad channel conditions, the WTRU may determine to use EBI reporting based on codepoints with strong channel error coding in addition to codepoints repetition. In an example, the WTRU may use short codepoints for the EBI reporting. In another example, the WTRU may use power boosting for the EBI report transmission. That is, the WTRU may determine, be configured, and/or indicated to use a second power boosting value (e.g., +Y dB (Y>X) compared to PUSCH UL power) for the EBI transmission.

When selecting 650 based on duplex mode, if the WTRU is FD capable and if the WTRU is configured with simultaneous PDSCH and PUSCH, such as PUSCH is fully or partially overlapping with the PDSCH, for example, method 600 may further include determining to send EBI based on ongoing PDSCH, such as based on measured DM-RS, for example, in a reserved EBI REs in the simultaneous ongoing PUSCH, such as using second type EBI occasions, for example. Alternatively, or additionally, the duplex mode may be configured to determine to send the EBI in the following slot in a TBoMS configuration.

In an example, a WTRU may determine the EBI reporting occasion types for EBI reporting in case the WTRU is configured and/or scheduled with simultaneous PDSCH and PUSCH. For example, the simultaneous PUSCH and PDSCH may be partially or totally overlapping in time. In an example, an SBFD WTRU or an FD WTRU may be scheduled with simultaneous UL and DL. As such, the WTRU may measure one or more quality parameters based on the received PDSCH. In an example, the WTRU may measure L1-RSRP, L1-RSSI, L1-RSRQ, hypothetical BLER, etc. For example, the WTRU may measure the quality parameters based on the received DM-RS of the PDSCH. Based on the measured quality parameters, the WTRU may determine if one or more of the L1 events may be triggered. In case one of the L1 events may be triggered, the WTRU may determine to transmit the codepoint corresponding to the triggered event based on EBI reporting.

In an example, the WTRU may determine to transmit the EBI reporting based on the second EBI reporting occasion type, e.g., if the time duration between the triggered event and the second EBI reporting occasion type is longer than a (pre)configured and/or indicated time threshold. The time threshold may correspond to WTRU's capability in TB generation for the PUSCH and corresponding multiplexing method (e.g., puncturing) for multiplexing the EBI reporting on the PUSCH.

In another example, if the time duration between the triggered event and the second EBI reporting occasion type is shorter than the time threshold, the WTRU may determine to transmit the EBI reporting in the next PUSCH or the next slot, e.g., in TBoMS framework. In case the WTRU transmits the EBI reporting in the next PUSCH or the next slot, the WTRU may select a first EBI reporting occasion type for the EBI reporting.

In an example, for an EBI reporting based on TBoMS that is configured based on transmitting the EBI reporting in EBI reporting occasions in a first (e.g., n-th) slot, the WTRU may determine, be configured, and/or indicated to determine a second slot for EBI reporting based on the PUSCH slot for which the overlapping with the simultaneous PDSCH takes place. For example, if the simultaneous PDSCH and PUSCH overlap on the third (e.g., k-th) slot of the PUSCH, the WTRU may determine the second slot to transmit the EBI reporting based on the first and the third (e.g., n+k-th) slot.

In an example, a WTRU may determine, be configured, and/or indicated to use different multiplexing methods for multiplexing one or more EBI reporting in one or more UL transmissions (e.g., PUSCH), based on one or more of time of EBI triggering and number of bits in the codepoint.

In an example, the WTRU may be configured and/or indicated to use rate-matching of the data for multiplexing the EBI reporting in the reserved bits. The WTRU may be configured and/or indicated to puncture the data REs that overlap with the PUSCH REs and send EBI reporting instead. For example, the WTRU may receive explicit indication and/or configuration information on the multiplexing methods to be used (e.g., via RRC, MAC-CE, DCI, etc.). In another example, the WTRU may determine the multiplexing methods (e.g., implicitly) based on one or more conditions. One or more of the following example conditions including time of EBI triggering and number of bits in the codepoint may apply.

For the time of EBI triggering, by way of example, if the time offset between the triggering of the event and the configured and/or scheduled (e.g., next) PUSCH is equal to or greater than a threshold delta-time, where the threshold is based on reported WTRU capability, the WTRU may use a first multiplexing method (e.g., rate-matching). That is, if the EBI reporting was triggered the delta-time in advance before the time of the PUSCH transmission, the WTRU may use the first multiplexing method (e.g., rate-matching). For example, the delta time may be configured and/or indicated, e.g., from a gNB, e.g., via SIB, RRC, MAC-CE, DCI, etc. In another example, the delta-time may be determined and/or reported by the WTRU as part of the WTRU capability reporting, for example based on WTRU's processing time needed for PUSCH TB generation. Alternatively, if the time offset between the triggering of the event and the configured and/or scheduled (e.g., next) PUSCH is less than the delta-time, the WTRU may use a second multiplexing method (e.g., puncturing PUSCH) to send the EBI reporting.

For the number of bits in the codepoint, by way of example, if the number of the bits in a codepoint used for reporting an EBI reporting occasion is larger than a configured limit and/or threshold, the WTRU may use the first multiplexing method (e.g., rate-matching). In another example, if the number of the bits in a codepoint used for reporting an EBI reporting occasion is smaller than the configured limit and/or threshold, the WTRU may use the second multiplexing method (e.g., puncture the PUSCH) to send the EBI reporting.

In an example, a WTRU may determine, be configured, and/or indicated to use one or more default, dummy, (pre)configured, and/or indicted codepoints in the reserved REs if no EBI reporting is available. The dummy codepoints may have different sizes or lengths. In an example, the WTRU may be configured with the multiplexing method to be used in case of different dummy codepoints. The WTRU may use the abovementioned conditions to determine the multiplexing method to be used for the different dummy codepoints. In another example, the WTRU may send the dummy codepoints only in case the resources for the EBI reporting are of the reserved REs. For example, in case the EBI reporting occasion type is of a first type where the EBI reporting resources are reserved and not available for PUSCH transmission, the WTRU may send dummy codepoints. In another example, in case the EBI reporting occasion type is of a second type where the EBI reporting resources are not reserved, the WTRU may not send dummy codepoints and may transmit the scheduled PUSCH data.

As set forth, at 660, method 600 includes transmitting a codepoint corresponding to the monitored event utilizing the selected EBI reporting occasion may occur. In an example, a WTRU may be configured with one or more codepoints for EBI reporting, where the codepoints may have different lengths. The codepoint lengths may be associated with type of the events and the types or details of the reports to be reported. The WTRU may select and/or determine the codepoint and the codepoint length to be used based on one or more conditions, including EBI reporting occasion type, power limits, events priority, etc., as described herein. The benefit in having different codepoints and different codepoint length is enabling adaptable UCI transmission with payload variations. The variations may be used based on collision and priority handling. In an example, the WTRU may determine, be configured, and/or indicated to handle the potential collisions in EBI report transmissions.

The PUSCH and PUCCH may be overlapping. For example, in case the configured and/or scheduled PUSCH overlaps with a PUCCH resource, the WTRU may send the EBI reporting as part of the PUCCH indication. In an example, the WTRU may send an SR via PUCCH indicating the EBI reporting available and requesting for a grant for the EBI report transmission.

If based on the PUSCH priority level, for example, the WTRU may be configured and/or scheduled with a PUSCH transmission for which the PUSCH priority level may be higher than the configured and/or indicated EBI reporting priority level. In an example, the WTRU may determine, be configured, and/or indicated to not transmit the EBI reporting and/or to skip the EBI reporting. In another example, in such cases, the WTRU may determine, be configured, and/or indicated to transmit the EBI reporting only in first EBI reporting occasion types. For example, the WTRU may not use the second EBI reporting occasion types in cases where the PUSCH occasions have a higher priority than the EBI occasions.

The configured grant and dynamic grant PUSCH may be overlapping. For example, in case a CG-PUSCH and a DG-PUSCH overlap in time and frequency resources, the WTRU may determine, be configured, and/or indicated to give higher priority to the dynamic grant. In general, in case of PUSCH occasions overlapping, the WTRU may use the EBI reporting occasions in the PUSCH occasion with higher priority.

A WTRU may transmit or receive a physical channel or reference signal according to at least one spatial domain filter. The term “beam” may be used to refer to a spatial domain filter. The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such an example, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such an example, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication”.

A property of a grant or assignment may one or more of a frequency allocation, an aspect of time allocation, such as a duration, a priority, a modulation and coding scheme, a transport block size, a number of spatial layers, a number of transport blocks, a TCI state, CRI or SRI, a number of repetitions, whether the repetition scheme is Type A or Type B, whether the grant is a configured grant type 1, type 2 or a dynamic grant, whether the assignment is a dynamic assignment or a semi-persistent scheduling (configured) assignment, a configured grant index or a semi-persistent assignment index, a periodicity of a configured grant or assignment, a channel access priority class (CAPC), and any parameter provided in a DCI, by MAC or by RRC for the scheduling the grant or assignment.

An indication by DCI may include one or more of an explicit indication by a DCI field or by RNTI used to mask or scramble the CRC of the DCI, and an implicit indication by a property such as DCI format, DCI size, Coreset or search space, Aggregation Level, first resource element of the received DCI (e.g., index of first Control Channel Element), where the mapping between the property and the value may be signaled by RRC or MAC. Receiving or monitoring for a DCI with or using an RNTI may mean that the CRC of the DCI is masked or scrambled with the RNTI.

In an example, a WTRU may be configured and/or indicated with one or more codepoints associated with different determined, configured, and/or indicated events to be transmitted in case an EBI reporting may be triggered. The WTRU may receive indications and/or configuration information on the codepoints to be used. The WTRU may receive the configuration information on the events that may be associated to each of the codepoints. After an activated event is triggered, the WTRU may send the codepoint that may be associated with the triggered event in one or more EBI reporting occasions. For example, the codepoints may indicate an event from a list and/or table of events, where the codepoints may be indicating the indexes to the (pre)configured and/or indicated events. As such, the WTRU may select and send the codepoint corresponding to the triggered event in EBI reporting occasions.

There may be more than one codepoint associated with a single event, where the different codepoints may carry information regarding the event and in addition to the event indication. For example, different codepoints may be transmitted based on the severity of the event in association with one or more threshold values and/or conditions. In an example, for L1-RSRP event, if the measured L1-RSRP is lower than a first configured threshold value, the WTRU may send a first configured codepoint in the EBI reporting occasions; if the measured L1-RSRP is higher than the first configured threshold value and lower than a second threshold value, the WTRU may send a second configured codepoint in the EBI reporting occasions, and so forth.

In an example, a WTRU may be configured with one or more (pre)configured, default, and/or dummy codepoints, where the WTRU may use the dummy codepoints in the reserved EBI reporting occasions in case none of the activated events are triggered. The WTRU may determine, be configured, and/or indicated to send some status information based on the reported dummy codepoint. For example, if the WTRU is not moving or if the WTRU is moving with the speed less than a speed threshold, the WTRU may send a first dummy codepoint; if the WTRU is moving faster than the speed threshold, the WTRU may send a second dummy codepoint. In another example, if the measured L1-RSRP is lower than a RSRP threshold, the WTRU may send a third dummy codepoint; if the measured L1-I-RSSI is higher than an interference threshold, the WTRU may send a fourth dummy codepoint, and so forth.

In an example, a WTRU may be configured to leave the reserved EBI reporting REs empty in a scenario where none of the activated events are triggered. The WTRU may determine, be configured, and/or indicated to not send any codepoints in the reserved EBI reporting REs empty in a scenario where none of the activated events are triggered.

In an example, the codepoints may have the same size (e.g., length, number of bits, etc.) or different sizes. The WTRU may send the short codepoints in any of the available and/or configured EBI reporting occasions, whereas the WTRU may send the longer codepoints only in the configured EBI reporting occasions with long enough number of reserved REs. In an example, the short codepoints may be used for high-level more urgent events, such as those with a higher priority, for example. The long codepoints may be used for indicating more details regarding an event, for example as a follow up to a short codepoint. In another example, the WTRU may use the short codepoints, such as those with higher channel error coding rates, for example in bad channel conditions (e.g., RSRP lower than a corresponding threshold). The WTRU may use the long codepoints, such as those with lower channel error coding rates, for example in good channel conditions (e.g., RSRP higher than the corresponding threshold), and so forth.

In an example, a WTRU may transmit more than one codepoint corresponding to one or more triggered events in an EBI reporting occasion. For example, the WTRU may send a first codepoint associated with a first event, a second codepoint associated with a second event, etc. in an EBI reporting occasion. In an example, the codepoints may be associated with different events. In another example, the codepoints may be associated with a single event, where the different codepoints may include extra details and/or information with regards to the triggered event.

Hereafter, for the brevity of discussion, the FD operation may comprise the SBFD operation, however the solutions and examples described herein may equally (or equivalently or extendedly, etc.) be employed (e.g., applicable) for cases with other FD operation types (e.g., IBFD, etc.).

A WTRU may be configured with one or more types of slots within a bandwidth, wherein a first type of slot may be used or determined for a first direction (e.g., downlink); a second type of slot may be used or determined for a second direction (e.g., uplink); a third type of slot may have a first group of frequency resources within the bandwidth for a first direction and a second group of frequency resources within the bandwidth for a second direction.

Downlink reception may be used interchangeably with Rx occasion, PDCCH, PDSCH, SSB reception.

Uplink transmission may be used interchangeably with Tx occasion, PUCCH, PUSCH, PRACH, SRS transmission.

Time instance, slot, symbol, and subframe may be used interchangeably.

The terms received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably.

The term CLI may be used interchangeably with interference.

The terms ‘paired spectrum’ and FDD may be used interchangeably.

The terms ‘unpaired spectrum’ and TDD may be used interchangeably.

The terms ‘WTRU is configured’, WTRU is indicated', ‘WTRU receives configuration’, and so forth, may imply that the configuration is indicated for example ‘via RRC, MAC-CE, DCI, MIB, SIB, and so forth’, unless indicated otherwise, where for example, ‘WTRU is configured’may imply ‘WTRU is configured via RRC, MAC-CE, MIB, SIB, and so forth’.

For the brevity of discussion, the channel quality parameters may comprise the RRM measurements, however the solutions and examples in the disclosure may equally (or equivalently or extendedly, etc.) be employed (e.g., applicable) for cases with other quality parameters and/or values (e.g., RSRP, RSRQ, SNR, SINR, etc.).

The term “event-based indication reporting occasions” may imply the reporting occasions in PUSCH resources, occasions, time instances, and so forth.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for a wireless transmit receive unit (WTRU) to perform event-based indication (EBI) multiplexing with one or more physical uplink (UL) shared channels (PUSCH), the method comprising:
receiving a message scheduling one or more PUSCH instances;
receiving configuration information indicating a plurality of resource elements (REs) for EBI that are configured to be multiplexed with one or more PUSCH;
monitoring for at least one event;
on a condition that a monitored event is triggered, selecting a PUSCH instance from the scheduled one or more PUSCH instances;
selecting an EBI reporting occasion in the selected PUSCH instance; and
transmitting a codepoint corresponding to the monitored event utilizing the selected EBI reporting occasion.

2. The method of claim 1, wherein the configuration information includes time and frequency resources of a plurality of EBI reporting occasions.

3. The method of claim 1, wherein the configuration information includes power configuration on EBI reporting.

4. The method of claim 1, wherein the configuration information includes one or more codepoints, each of the one or more codepoints being associated with one or more L1 events.

5. The method of claim 1, wherein the configuration information includes at least one EBI reporting occasion type, the at least one EBI reporting occasion type including at least one of:
a first type EBI reporting occasion with reserved REs for EBI reporting; and
a second type EBI reporting occasion without reserved REs for EBI reporting.

6. The method of claim 1, wherein the configuration information includes at least one of EBI repetition, priority levels, error control coding, and carrier configuration.

7. The method of claim 1, wherein the monitoring for at least one event includes monitoring for at least one of strong CLI, high hypothetical block error rate (BLER), low reference signal received power (RSRP), low signal-to-noise ratio (SNR), beam reporting, or LTM events.

8. The method of claim 1, wherein the monitoring for at least one event is based on at least one of one or more channel or interference measurements, or one or more reference signals.

9. The method of claim 1, wherein the selected PUSCH instance is the closest available in time to the triggering based on the monitored event.

10. The method of claim 1, further comprising determining the codepoint to be used to report the triggered monitored event.

11. The method of claim 1, wherein the selected EBI reporting occasion is selected based on at least one of time limits, power or duplex mode.

12. The method of claim 11, wherein the time limit for selecting the EBI reporting occasion is based on at least one of:
if the time offset between the triggering of the event and the selected PUSCH instance is equal to or greater than a threshold delta-time, where the threshold is based on reported WTRU capability, the method further comprises determining to use a first type EBI occasion;
if the time offset between the triggering of the event and the selected PUSCH instance is smaller than a delta-time, the method further comprises determining to use a second type EBI occasion; and
if the event is detected after a configured time-window after a beginning of a slot, the method further comprises determining to use a next PUSCH instance or a next slot in TBoMS framework.

13. The method of claim 11, wherein the time limit for selecting the EBI reporting occasion is based on at least one of:
if PUSCH length<L1, determining to use a second type EBI occasion; and
if PUSCH length>L1, determining to use a first type EBI occasion.

14. The method of claim 11, wherein the power for selecting the EBI reporting occasion is configured according to one of
if good channel conditions exist, the method further comprises determining to not use polar coding for the codepoint and to use first type EBI occasions;
if mediocre channel conditions exist, the method further comprises determining to use polar coding for the codepoint;
if bad channel conditions exist, the method further comprises determining to send the EBI with power boosting; and
if very bad channel conditions exist, the method further comprises determining to use repetition.

15. The method of claim 11, wherein the duplex mode is configured such that if the WTRU is FD capable and if the WTRU is configured with simultaneous PDSCH and PUSCH, the method further comprises determining to send EBI based on ongoing PDSCH in a reserved EBI REs in the simultaneous ongoing PUSCH.

16. The method of claim 11, wherein the duplex mode is configured to determine to send the EBI in the following slot in a TBoMS configuration.

17. A wireless transmit receive unit (WTRU) comprising:
a processor;
a transceiver operably connected to the processor, the transceiver and processor configured to:
receive a message scheduling one or more physical uplink (UL) shared channels (PUSCH) instances;
receive configuration information indicating a plurality of resource elements (REs) for event-based indication (EBI) that are configured to be multiplexed with one or more PUSCH;
monitor for at least one event;
on a condition that a monitored event is triggered, select a PUSCH instance from the scheduled one or more PUSCH instances;
select an EBI reporting occasion in the selected PUSCH instance; and
transmit a codepoint corresponding to the monitored event utilizing the selected EBI reporting occasion.

18. The WTRU of claim 17, wherein the monitoring for at least one event includes monitoring for at least one of strong CLI, high hypothetical block error rate (BLER), low reference signal received power (RSRP), low signal-to-noise ratio (SNR), beam reporting, or LTM events.

19. The WTRU of claim 17, wherein the processor and transceiver are further configured to determine the codepoint to be used to report the triggered monitored event.

20. The WTRU of claim 17, wherein the selected EBI reporting occasion is selected based on at least one of time limits, power or duplex mode.
